(19) United States
(12) Patent Application Publication
(10) Pub. No.: US 2025/0385297 A1
(43) Pub. Date: Dec. 18, 2025

(54) Electrolyte for Lithium-ion Batteries Under Extreme Operating Conditions

(71) Applicant: University of Maryland, College Park, College Park, MD (US)

(72) Inventors: Chunsheng Wang, Silver Spring, MD (US); Jijian Xu, College Park, MD (US)

(21) Appl. No.: 19/130,454

(22) PCT Filed: Nov. 14, 2023
(86) PCT No.: PCT/US23/79701

§ 371 Date: May 15, 2025

Related U.S. Application Data
(60) Provisional application No. 63/384,048, filed on Nov. 16, 2022.

(51) Int. Cl. H01M 10/0525; H01M 4/02; H01M 4/505; H01M 4/525; H01M 4/583; H01M 4/62; H01M 4/66; H01M 4/75; H01M 10/0568; H01M 10/0569; H01M 50/105

(52) U.S. Cl. CPC H01M 10/0525; H01M 4/505; H01M 4/525; H01M 4/583; H01M 4/623; H01M 4/625; H01M 4/661; H01M 4/75; H01M 10/0568; H01M 10/0569; H01M 50/105; H01M 2004/027; H01M 2004/028; H01M 2300/0034; H01M 2300/004

(57) ABSTRACT

This present disclosure is directed to electrolyte compositions for Li-ion batteries, the preparation of said batteries, and uses thereof. Examples of electrolyte compositions disclosed herein allow for Li-ion battery use in extreme operating conditions over a wide temperature range, allowing for efficient use at both high and low temperatures.

### CROSS REFERENCE TO RELATED APPLICATION(S)

This application claims priority to U.S. Application No. 63/384,048, filed on Nov. 16, 2022, the contents of which are hereby incorporated by reference in its entirety.

### STATEMENT OF FEDERALLY SPONSORED RESEARCH AND DEVELOPMENT

This invention was made with government support under DESC0012704 awarded by the U.S. Department of Energy. The government has certain rights in the invention.

### FIELD OF THE INVENTION

The field of the invention relates generally to electrochemical cells, and more particularly, to electrolytes and electrolyte designs for electrochemical cells such as lithium-ion batteries.

### BACKGROUND

This background information is provided for the purpose of making information believed by the applicant to be of possible relevance to the present invention. No admission is necessarily intended, nor should it be construed, that any of the information disclosed herein constitutes prior art against the present invention.

State-of-the-art electrolytes based on carbonate esters fail to meet most of the requirements for extreme Li-ion batteries (LIBs) because their voltage window is limited to 4.3 V, they have a narrow operating temperature range of −20 to +50° C., and are highly flammable. Enabling low-temperature operation has been achieved previously by reducing the freezing point of the electrolyte through the introduction of a series of co-solvents with a low freezing point, such as linear carboxylate esters and ethers. However the narrower electrochemical stability of these esters and ethers of 1.5-4.7 V (vs. Li+/Li) sets an upper limit on the battery voltage. Recent breakthroughs in low-temperature batteries via liquefied gas electrolytes are able to retain >60% of room temperature capacity even at −60° C., but the low boiling point of these volatile solvents requires hermetical cell redesign under pressures needed for gas liquefaction.

In addition to ionic conductivity, the interfacial/interphasial resistance dominates at low temperatures requiring electrolytes to have low Li⁺ desolvation energy. Due to the joint effects of large charge transfer and low ion conductivity below −20° C., high overpotentials reduce accessible capacity and lead to Li⁰ plating on the graphite surface. Li⁰ plating on graphite accelerates capacity decay and reduces the Coulombic efficiency (CE) to <99.5%. Furthermore, Li dendrite growth may shorten the cell presenting a safety hazard. To circumvent Li⁰ plating on graphite at low temperatures, a common practice is to employ a relatively high N/P capacity ratio in commercial LIBs, which ensures better safety at the expense of overall energy density. However, Li dendrites may still occur under fast charging or extremely low temperatures (<−20° C.) because the charge/discharge kinetics between graphite anode and NMC cathode are different. Since the charge/discharge kinetics of the electrodes are largely controlled by the interphases, an ideal low-temperature electrolyte should form kinetically matched interphases on both electrodes to achieve low and equivalent overpotentials at different temperatures and currents.

### BRIEF DESCRIPTION OF THE FIGURES

The following drawings form part of the present specification and are included to further demonstrate certain aspects of the present invention. The invention may be better understood by reference to one or more of these drawings in combination with the detailed description of specific embodiments presented herein.

FIGS. 1A-D. Electrolyte design strategies. FIG. 1A displays an illustration of the soft solvation between the soft solvent and Li-ions, rapid Li-ion transport, and wide-temperature (±60° C.) stability. FIG. 1B displays the solvent diagram of donor number vs. dielectric constant. Solvents located at zone IV are denoted as soft solvents, in which the lower donor number and higher dielectric constant effectively reduce Li⁺-solvent affinity without sacrificing kinetic transportation. FIG. 1C displays the Li⁺-solvent binding energy from DFT calculations vs. experimental dielectric constant. FIG. 1D displays the chemical structure of the soft solvating solvents.

FIGS. 2A-H. Physical properties of the electrolytes. FIG. 2A displays Raman spectra of 1M LiTFSI in different solvents. FIG. 2B displays a summary of Δδ (¹³C NMR spectra of carbonyl carbons) in different solvents with and without LiTFSI. FIG. 2C displays a temperature dependence of the conductivity of different electrolytes. For comparison, red stars represent conductivity values predicted with Molecular dynamics (MD). FIG. 2D displays DSC cooling and heating curves of different electrolytes. FIG. 2E displays PDF data of 1 M LiTFSI MDFA/MDFSA-TTE electrolyte, and single solvents. Greyline: experiment data; Redline: MD simulation predictions. FIGS. 2F-H display MD simulation results: FIG. 2F displays a snapshot of the simulation box of 1M MDFA/MDFSA-TTE. In FIG. 2F, LiTFSI-MDFA are highlighted by yellow isosurface, TTE and MDFSA by blue isosurface; FIG. 2G displays representative ionic aggregates from MD simulation at 25° C. Jmol color schemes are used: Li—purple, N—blue, F—green, S—yellow, C—grey, O—red, H—white. FIG. 2H displays the fraction of free Li⁺ and TFSI⁻ defined as the ions not coordinated to any counterion within 5.0 Å of Li—N(TFSI), degree of dynamics uncorrelated motion ad (ionicity) from MD simulations of 1M LiTFSI in MDFA/MDFSA-TTE electrolyte.

FIGS. 3A-G. Electrochemical performance of NMC811∥graphite full cells. FIG. 3A displays the cycling performance at 0.5 C under 25° C. FIG. 2B displays a rate performance at 25° C. FIG. 3C displays the corresponding voltage profiles of FIG. 3B. FIG. 3D displays long cycling performance at 0.2 C under −30/−40° C. FIG. 3E displays cycling performance at 0.1 C under different temperatures (60° C., 25° C., 0° C., −20° C., −30° C., −40° C., −50° C., −60° C.). FIG. 3G displays the corresponding voltage profiles of cells in FIG. 3E using 1M LiTFSI MDFA/MDFSA-TTE electrolyte. FIG. 3G displays the pouch cell performance at −30° C. and rate of 0.2 C using 2.5 g/Ah or 3.5 g/Ah electrolytes. Rate performance was conducted using the cell with electrolyte of 3.5 g/Ah (red line) at different C-rates (0.2 C for 5 cycles, 0.3 C for 5 cycles, 0.4 C for 5 cycles and 0.2 C for 345 cycles). The inset shows a photo of 4.5 V pouch cell.

FIGS. 4A-H. Characterization of SEI layers on graphite anode after cycling at −30° C. FIG. 4A displays HRTEM images with 1M LiTFSI MDFA/MDFSA-TTE electrolyte. FIG. 4B displays HRTEM images with 1M LiPF₆ EC/DEC electrolyte. FIGS. 3C-D display the morphology of graphite electrode before and after cycling in 1M LiPF₆ EC/DEC electrolyte, respectively. FIG. 4E displays the morphology of graphite electrode after cycling in 1M LiTFSI MDFA/MDFSA-TTE electrolyte. AFM roughness (R) comparison on an area of 0.5 μm×0.5 μm. FIGS. 4F-H display the XPS results of the SEI on cycled graphite in 1M LiTFSI MDFA/MDFSA-TTE electrolyte. FIG. 4F displays quantified atomic ratios of the elements in SEI. FIGS. 4G-H display C 1s and F 1s spectra, respectively, displayed in columns of the corresponding depth profiling results.

FIGS. 5A-E. Illustration of the capacity matching and kinetic matching. FIG. 5A displays the thick interface between the commercial carbonate-based electrolyte and lithiated graphite anodes. FIG. 5B displays the self-limiting interface between the designed electrolyte and lithiated graphite anodes. FIGS. 5C-E display schematic illustrations of capacity mismatching as a function of charge rate or charge temperature, capacity matching as a function of charge rate or charge temperature, and resistance matching between anode and cathode, respectively.

FIGS. 6A-B. FIG. 6A displays X-ray measurements. FIG. 6B displays MD simulation results. A structure factor S(Q) from X-ray measurements (solid black line) and MD simulations (blue dash) for 1M LiTFSI in MDFA/MDFSA-TTE electrolyte and two dominating solvents MDFA and TTE. S(Q) for MDFA and TTE were shifted by −1.5 and 3.0.

FIGS. 7A-E. MD simulation results. FIGS. 7A-B display a snapshot of MD simulation box of LiTFSI in MDFA and in 1M LiTFSI in MDFA/MDFSA-TTE, respectively, from MD simulations at 25° C. Solvent is shown as wireframe. FIG. 7C displays the structure of Li⁺(MDFA)₄ free Li⁺ (solvent separated from TFSI⁻) from MD simulation of 1M LiTFSI in MDFA/MDFSA-TTE (FIG. 7B) at 25° C. Jmol color scheme are used: Li—purple, N—blue, F—green, S—yellow, C—grey, O—red, H—white. FIG. 7D displays ion and solvent self-diffusion coefficients from MD simulations of 1M LiTFSI in MDFA/MDFSA-TTE electrolyte. FIG. 7E displays the conductivity of 1M LiTFSI in MDFA-MDFSA-TTE electrolyte from MD simulations and experiments.

FIGS. 8A-F. Rate performance of polycrystalline NMC811∥graphite pouch cells at 25° C. Pouch cells with different amounts of 1M LiTFSI MDFA/MDFSA-TTE electrolyte under 3 C, and 4 C. FIG. 8A displays 3.5 g/Ah of electrolyte at 3 C. FIG. 8B displays 3.5 g/Ah of electrolyte at 4 C. FIG. 8C displays 3.0 g/Ah of electrolyte at 3 C. FIG. 8D displays 3.0 g/Ah of electrolyte at 4 C. FIG. 8E displays 2.5 g/Ah of electrolyte at 3 C. FIG. 8F displays 2.5 g/Ah of electrolyte at 4 C.

FIG. 9. Cycling performance of NMC811∥graphite full cells at 0.1 C under −50/60° C.

FIGS. 10A-D. Kinetic analysis of the low-temperature process. FIG. 10A displays a cell illustration of three-electrode set up for kinetic analysis. FIG. 10B displays the cell voltage and electrode potential of NMC811∥graphite pouch cells in 0.2 C under −30° C. FIGS. 10C-D display Nyquist impedance plots and fitted lines using the equivalent circuit of the three-electrode cells containing 1M LiTFSI MDFA/MDFSA-TTE electrolyte at 25° C. and −30° C., respectively. Impedance spectra were obtained at 50% SOC.

FIGS. 11A-C. DFT calculations of reaction energies. FIGS. 11A-C displays reaction energies from PBE+U (red) and SCAN (blue) (units: eV) for dehydrogenation of MDFA on Li_{0.5}NiO₂, TTE on Li_{0.5}NiO₂, and Li⁺-MDFSA on Li_{1.0}NiO₂, respectively. A single F-ion is present on the surface as well to neutralize the cell in FIG. 11C.

FIGS. 12A-C. FIG. 12A displays the binding energies for the Li⁺(MDFA)₃(solvent) solvates vs. Li⁺(solvent) for the indicated solvents in implicit ether solvent. FIG. 12B displays the difference between the Li⁺(MDFA)₃(solvent) and Li⁺(solvent) binding energies indicating the steric hindrance and cross interaction between solvents in the Li⁺(MDFA)₃(solvent) solvate that tends to increase with the increasing molecular size and the number of solvating groups. FIG. 12C displays the Li⁺(MDFA)₃(solvent) binding energy from DFT calculations vs. experimental dielectric constant.

FIGS. 13A-D. FIGS. 13A-D display independent CV profiles of graphite electrodes in different electrolytes. FIG. 10A displays the CV of 1M LiTFSI in MDFA-TTE. FIG. 10B displays the CV of 1M LiTFSI in MDFA/MDFSA-TTE. FIG. 10C displays the CV of 1M LiTFSI in EDFA/MDFSA-TTE. FIG. 10D displays the CV of 1M LiTFSI in M4FP/MDFSA-TTE. The inset in FIG. 13B displays the enlarged region from 2.0-2.5 V, demonstrating the small reduction peak at ˜2.2V. Such a higher voltage reduction peak is absent in the MDFA-free electrolytes allowing assignment to the MDFA reduction in accord with QC results.

FIG. 14. FIG. 14 displays photos of flammability tests of glass fibers saturated with electrolytes with different volume ratios of TTE.

FIGS. 15A-B. FIG. 15A displays Raman spectra of MDFA-based electrolytes with different LiTFSI concentrations. FIG. 15B displays Raman spectra of 1M LiFSI in weakly solvating solvents.

FIGS. 16A-D. FIG. 16A displays the ¹³C NMR spectra of LiTFSI saturated MA and neat MA solvent. FIG. 16B displays the ¹³C NMR spectra of LiTFSI saturated EDFA and neat EDFA solvent. FIG. 16C displays the ¹³C NMR spectra of LiTFSI saturated MDFA and neat MDFA solvent. FIG. 16D displays the ¹³C NMR spectra of LiTFSI saturated M4FP and neat M4FP solvent.

FIGS. 17A-D. FIG. 17A displays the ¹⁷O NMR spectra of LiTFSI saturated MDFA and neat MDFA solvent. FIG. 17B displays the ¹⁷O NMR spectra of LiTFSI saturated EDFA and neat EDFA solvent. FIG. 17C displays the ¹⁷O NMR spectra of LiTFSI saturated MTFP and neat MTFP solvent. FIG. 17D displays a summary of Δδ (¹⁷O NMR spectra of carbonyl oxygens) in different solvents with and without LiTFSI.

FIGS. 18A-B. FIG. 18A displays optical images of different electrolytes after storage at −30° C. overnight. FIG. 18B displays optical images of different electrolytes after storage −90° C. overnight.

FIGS. 19A-E. FIG. 19A displays the oxidation stability for different electrolytes evaluated on Pt electrodes at a scanning rate of 1 mV/s. FIG. 19B displays a floating test of 1 M LiTFSI MDFA/MDFSA-TTE and 1 M LiTFSI M4FP/MDFSA-TTE electrolytes. FIG. 19C displays an SEM image of fresh aluminum foil. FIGS. 19D-E displays SEM images of aluminum foil after holding in 1 M LiTFSI MDFA/MDFSA-TTE electrolyte at 4.5 V for 24 h and 48 h, respectively.

FIG. 20. FIG. 20 displays a walden plot relating molar conductivity (A) and fluidity (inverse viscosity (1/n) for LiTFSI in MDFA and MDFA/MDFSA-TTE electrolytes from MD simulations and experiment.

FIGS. 21A-B. FIG. 21A displays a polarization curve of the Li∥Li cell with 1M LiTFSI MDFA/MDFSA-TTE electrolyte with an applied voltage of 5 mV. I₀ indicates the initial current, Iₛₛ indicates the steady state current. FIG. 21B displays impedance spectra before and after the polarization. Without wishing to be limited by any particular theory, for conventional 1M LiPF₆ EC/DEC electrolyte, using the identical potentiostatic polarization method, a transference number (t+) of 0.33 is calculated by:

$${t}_{+} = {I}_{s s} ( ΔV - {I}_{0} {R}_{0} ) / {I}_{0} ( ΔV - {I}_{s s} {R}_{s s} ) .$$

FIGS. 22A-B. FIG. 22A displays ion and solvent self-diffusion coefficients from MD simulations of 1M LiTFSI in MDFA/MDFSA-TTE electrolyte. FIG. 22B displays the conductivity of 1M LiTFSI in MDFA-MDFSA-TTE electrolyte from MD simulations and experiments.

FIGS. 23A-B. FIG. 23A displays typical voltage profiles of 1^{st} formation cycle at 0.2 C of NMC811∥graphite full cells with 1M LiTFSI MDFA/MDFSA-TTE electrolyte. FIG. 23B displays selected voltage profiles of the 1^{st}, 100th, and 400th cycles at 0.5 C of NMC811∥graphite full cells with 1M LiTFSI MDFA/MDFSA-TTE electrolyte.

FIG. 24. FIG. 24 displays the cycling performance at 0.5 C under 25° C. of NMC811∥graphite full cells with 1 M LiTFSI MDFA-TTE electrolyte.

FIG. 25. FIG. 25 displays the cycling performance at 0.5 C under 25° C. of NMC811∥graphite full cells with 1 M LiTFSI MDFA/MTFSP-TTE or 1 M LiTFSI MDFA/NFSF-TTE electrolytes with the illustration of molecular structures of MDFA, MDFSA, methyl 2,3,3,3-tetrafluoro-2-(fluorosulfonyl) propionate (MTFSP), and nonafluorobutanesulfonyl fluoride (NFSF) with the same fluorosulfonyl group.

FIGS. 26A-B. FIG. 26A displays a photograph of the EL-CELL device. FIG. 26B displays pressure evolution with NMC811∥graphite full cells cycled at 0.5 C containing 1M LiTFSI MDFA/MDFSA-TTE and 1M LiPF₆ EC/DEC electrolytes with cutoff voltages of either 4.3 V or 4.5 V.

FIG. 27. FIG. 27 displays typical charge/discharge voltage profiles at different C-rates of NMC811∥graphite full cells with 1M LiPF₆ EC/DEC electrolyte.

FIGS. 28A-D. FIGS. 28A-B display typical SEM images of single-crystalline NMC811. FIGS. 28C-D display typical SEM images of poly-crystalline NMC811.

FIGS. 29A-D. FIGS. 29A-B display rate performances of NMC 811/Li and graphite/Li half cells, respectively, containing 1M LiTFSI MDFA/MDFSA-TTE electrolyte. FIG. 29C displays the N/P ratio under different C-rates: 1 C=2.5 mA/cm², 2 C=5.0 mA/cm², 3 C=7.5 mA/cm², 4 C=10 mA/cm². FIG. 29D displays a photo of graphite anode from the dissembled pouch cell cycled under −30° C.

FIGS. 30A-B. FIG. 30A displays the cycling performance at 0.5 C under 60° C. of NMC811∥graphite full cells with different electrolytes. FIG. 30B displays the cycling performance at 4 C under 60° C. of NMC811∥graphite pouch cells with varying amounts of 1 M LiTFSI MDFA/MDFAS-TTE electrolytes (3.5, 3.0, 2.5 g/Ah).

FIGS. 31A-B. FIGS. 31A-B display Nyquist impedance plots of the three-electrode cells containing 1M LiPF₆ EC/DEC electrolyte under 25° C. and −30° C., respectively. Impedance spectra were obtained at 50% SOC.

FIGS. 32A-B. FIGS. 32A-B display XRD patterns of the graphite anode collected from NMC811∥graphite full cells containing 1M LiPF₆ EC/DEC and 1M LiTFSI MDFA/MDFSA-TTE, respectively, after 20 cycles at 0.2 C under −30° C.

FIGS. 33A-C. FIG. 33A displays an SEM image of the pristine graphite anode. FIGS. 33B-C display cycled graphite anodes collected from NMC811∥graphite full cells containing 1M LiPF₆ EC/DEC and 1M LiTFSI MDFA/MDFSA-TTE, respectively, after 20 cycles at 0.2 C under −30° C.

FIGS. 34A-C. FIG. 34A displays the surface morphology of cycled graphite anodes using 1M LiTFSI MDFA/MDFSA-TTE electrolyte for TOF-SIMS analysis over a 2×2 μm² raster size. FIGS. 34B-C display the mapping of F⁻ and the corresponding TOF-SIMS depth profiles O⁻, F⁻, and C⁻ secondary ions on the cycled graphite anodes, respectively.

FIGS. 35A-D. XPS characterization of the SEI formed on graphite cycled using 1M LiPF₆ EC/DEC electrolyte. FIG. 35A displays the quantified atomic ratios of the elements in SEI. FIGS. 35B-D display the C 1s, O 1s, F 1s spectra, respectively, displayed in columns of the corresponding depth profiling results.

FIG. 36. FIG. 36 displays XRD patterns of the pristine NMC811 cathode, cycled cathode with 1M LiPF₆ EC/DEC, and cycled cathode with 1 M LiTFSI MDFA/MDFSA-TTE electrolytes.

FIGS. 37A-B. FIG. 37A displays an HRTEM image of a cycled NMC811 cathode under −30° C. with 1M LiTFSI MDFA/MDFSA-TTE electrolyte. FIG. 37B displays an HRTEM image of a cycled NMC811 cathode under −30° C. with 1M LiPF₆ EC/DEC electrolyte.

FIGS. 38A-B. FIGS. 38A-B display XPS characterization of the CEI formed on cycled NMC811 using 1M LiTFSI MDFA/MDFSA-TTE electrolyte for C 1s and F 1s spectra, respectively, displayed in columns of the corresponding depth profiling results.

FIGS. 39A-C. FIG. 39A displays the surface morphology of cycled NMC811 cathodes using 1M LiTFSI MDFA/MDFSA-TTE electrolyte for TOF-SIMS analysis over a 2×2 μm² raster size. FIGS. 39B-C display the mapping of F⁻ and the corresponding TOF-SIMS depth profiles O⁻, F⁻, and C⁻ secondary ions on the cycled NMC811, respectively.

FIGS. 40A-D. FIGS. 40A-D display the partial density of states of LiNiO₂ from PBE+U (U=5.96 eV for Ni), LiNiO₂ from SCAN, Li_{0.5}NiO₂ from PBE+U, and Li_{0.5}NiO₂ from SCAN, respectively. Structures from optimization with PBE+U with 520 eV cutoff, single point energies with SCAN use 800 eV cutoff.

### DESCRIPTION

### 1.0 Definitions

For the purposes of promoting an understanding of the principles of the invention, reference will now be made to certain embodiments and specific language will be used to describe the same. It will nevertheless be understood that no limitation of the scope of the invention is thereby intended, and alterations and modifications in the illustrated invention, and further applications of the principles of the invention as illustrated therein are herein contemplated as would normally occur to one skilled in the art to which the invention relates.

Unless defined otherwise, all technical and scientific terms used herein have the same meaning as commonly understood by one of ordinary skill in the art to which this invention pertains.

For the purpose of interpreting this specification, the following definitions will apply and whenever appropriate, terms used in the singular will also include the plural and vice versa. In the event that any definition set forth below conflicts with the usage of that word in any other document, including any document incorporated herein by reference, the definition set forth below shall always control for purposes of interpreting this specification and its associated claims unless a contrary meaning is clearly intended (for example in the document where the term is originally used).

The use of “or” means “and/or” unless stated otherwise.

The use of “a” or “an” herein means “one or more” unless stated otherwise or where the use of “one or more” is clearly inappropriate.

The use of “comprise,” “comprises,” “comprising,” “include,” “includes,” and “including” are interchangeable and not intended to be limiting. Furthermore, where the description of one or more embodiments uses the term “comprising,” those skilled in the art would understand that, in some specific instances, the embodiment or embodiments can be alternatively described using the language “consisting essentially of” and/or “consisting of.”

As used herein, the term “about” refers to a ±10% variation from the nominal value. It is to be understood that such a variation is always included in any given value provided herein, whether or not it is specifically referred to.

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Moreover, all ranges disclosed herein are to be understood to encompass any and all subranges (including all fractional and whole values) subsumed therein.

The term “NMC811” as used herein refers to the chemical composition comprising LiNi_{0.8}Mn_{0.1}Co_{0.1}O₂.

The term “M3FP” as used herein refers to methyl 3,3,3-trifluoropropionate.

The term “M4FP” as used herein refers to methyl-2,3,3,3-tetrafluoropropionate.

The term “MDFA” as used herein refers to methyl difluoroacetate.

The term “MDFSA” as used herein refers to methyl-2,2-difluoro-2-(fluorosulfonyl)acetate.

The term “EDFA” as used herein refers to ethyl difluoroacetate.

The term “TTE” as used herein refers to 1,1,2,2-tetrafluoroethyl-2,2,3,3-tetrafluoropropylether.

The term “LiTFSI” as used herein refers to the salt lithium bis(trifluoromethanesulfonyl)imide, also known as lithium bistriflimide.

The term “SEI” as used herein refers to the solid-electrolyte interphase layer. Typically, the layer is formed upon initial cycling of the battery on the surface of the anode material due to partial electrolyte decomposition.

The term “CEI” as used herein refers to the cathode-electrolyte interphase later.

The term “PVDF” as used herein refers to polyvinylidene fluoride.

### 2.0 Electrolyte Design for Li-Ion Batteries Under Extreme-Operating Conditions

The ideal electrolyte for the widely-used LiNi_{0.8}Mn_{0.1}Co_{0.1}O₂ (NMC811)∥graphite Li-ion batteries is expected with the capability of supporting higher voltages (≥4.5 V), fast-charging (≤15-min), charging/discharging over a wide temperature range (±60° C.) without Li plating, and non-flammability. No existing electrolyte simultaneously meets all these requirements and electrolyte design is hindered by the absence of an effective guiding principle that addresses the relationships between battery performance, solvation structure, and solid-electrolyte-interphase chemistry. Herein, an electrolyte design strategy based on a group of soft solvents that strike a balance between weak Li⁺-solvent interactions, sufficient salt dissociation, and desired electrochemistry to fulfill all the aforementioned requirements are reported and validated. Remarkably, the 4.5 V NMC811∥graphite coin cells with areal capacities of more than 2.5 mAh/cm² retain 75% (54%) of their room temperature capacity when these cells are charged and discharged at −50° C. (−60° C.) at 0.1 C, while the NMC811∥graphite pouch cells with lean electrolyte (2.5 g/Ah) achieve stable cycling with an average Coulombic efficiency of >99.9% at −30° C. The comprehensive analysis further reveals an impedance matching between NMC811 cathode and graphite anode due to the formation of similar LiF-rich interphases, thus effectively avoiding lithium plating at low temperatures. The new electrolyte design principle can be extended to other alkali-metal ion batteries operating under extreme conditions.

### 2.1 Non-Limiting Embodiments

One aspect of the invention pertains to an electrolyte composition, said composition comprising a lithium salt dissolved in one or more solvents, wherein said solvent has donor number <10, dielectric constant >5, boiling point greater than 60° C., and melting points less than −60° C. The electrolyte composition may be composed of soft solvents. Without wishing to be limited to any particular theory, it is contemplated that the solvent(s) and lithium salt interacts in an intermediate manner, such that the solvent(s) may offer sufficient lithium sat dissociation, but also minimize lithium salt solution interactions, wherein the Li⁺-solvent interactions are weak. Examples of solvents that may be used in the electrolyte compositions disclosed herein include MDFA, MDFSA, M4FP, EDFA, and M3FP, or combinations thereof. In some embodiments, the solvent in the electrolyte composition is MDFA. In other embodiments, the solvent in the electrolyte composition is a mixture of MDFA and MDFSA. In further embodiments, the electrolyte composition comprises a mixture of MDFA, MDFSA and TTE.

In some embodiments, the electrolyte composition comprises MDFA in an amount in the range of about 20% to about 50%. In some embodiments, the electrolyte composition comprises MDFSA in an amount in the range of about 10% to about 25%. In some embodiments, the electrolyte composition comprises TTE in an amount in the range of about 30% to about 60%. In further embodiments, the electrolyte composition comprises at least 40% TTE by volume. In some embodiments, the electrolyte composition comprises MDFA, MSFSA, and TTE (for example, in a 4:1:5 volume ratio), respectively.

The electrolyte composition may also comprise a lithium salt. Examples of lithium salts that may be used include LiTFSI, LiClO₄, LiI, LiBF₄, LiCF₃SO₃, LiNO₃, LiBr, and LiCF₃CO₂, or a combination thereof. In some embodiments, the lithium salt in the electrolyte composition is LiTFSI.

In some embodiments, the lithium salt in the electrolyte composition has a concentration in the range of about 0.5 M to about 4 M. In some embodiments, the lithium salt in the electrolyte composition has a concentration in the range of about 1 M to about 2 M. In further embodiments, the lithium salt in the electrolyte composition has a concentration of about 1 M.

In some embodiments, the electrolyte composition comprises LiTFSI at about 1 M in a mixture of MDFA, MDFSA, and TTE solvents in a volume ratio of about 4:1:5.

Another aspect of the invention pertains to a Li-ion battery, wherein said battery may comprise a cathode, an anode, and an electrolyte of any of the preceding embodiments. In some embodiments, the cathode comprises NMC811. In some embodiments, the cathode comprises NMC811, and further comprises a mixture of PVDF and carbon black. In some embodiments, the cathode comprises about 80% to about 98% NMC811, about 1% to about 10% PVDF, and about 1% to about 10% carbon black. In some embodiments, the cathode comprises about 90% to about 95% NMC811, about 3% to about 5% PVDF, and about 2% to about 5% carbon black. In some embodiments, the cathode comprises about 90% to about 95% NMC811, about 2.5% to about 5% PVDF, and about 2.5% to about 5% carbon black. In further embodiments, the cathode comprises about 94% NMC811, about 3% PVDF, and about 3% carbon black.

In some embodiments, the anode of said Li-ion battery comprises graphite. In some embodiments, the anode comprises graphite, and further comprises a mixture of PVDF and carbon black. In some embodiments, the anode comprises about 80% to about 98% graphite, about 1% to about 10% PVDF, and about 1% to about 10% carbon black. In some embodiments, the anode comprises about 90% to about 95% graphite, about 4% to about 7% PVDF, and about 1% to about 3% carbon black. In some embodiments, the anode comprises about 90% to about 95% graphite, about 3% to about 5% PVDF, and about 2% to about 5% carbon black. In further embodiments, the anode comprises about 92% graphite, about 6% PVDF, and about 2% carbon black by weight.

In some embodiments of the invention, the battery has an operational charging and discharging temperature in the range of about −120° C. to about 120° C. In further embodiments, the battery has an operational charging and discharging temperatures in the range of about −90° C. to about 90° C., or about −60° C. to about 60° C., or about −30° C. to about 30° C.

An additional aspect of the invention pertains to a method of assembling a Li-ion battery comprising preparing multiple layers of cathode, electrolyte, and anode. For example, said method comprises layering a cathode disclosed herein, a separator material, an anode disclosed herein, and an electrolyte composition disclosed herein. In some embodiments, the separator material is CELGARD 2325R, CELGARD 3501R, CELGARD 2500R, or CELGARD pp 1410R. In further embodiments, the amount of electrolyte composition used is in the range of about 20 μL to about 80 μL, or about 30 μL to about 70 μL, or about 40 to about 60 μL.

In some embodiments, the battery is a coin cell type battery. In some embodiments, said cathode is coated onto a metal such as aluminum foil. The anode may also be coated onto a metal such as Cu foil.

In some embodiments, the battery is a pouch cell type battery. In some embodiments, the cathode disclosed herein is attached (e.g., via electrode tabs) to a metal strip (such as an aluminum strip). The anode may be attached (e.g., via electrode tabs) to a metal strip (such as a nickel strip). In further embodiments, the amount of electrolyte composition of the preceding embodiments used is in the range of about 2 g/Ah to about 8 g/Ah, or about 2.5 g/Ah to about 6.5 g/Ah, or about 3 g/Ah to about 5 g/Ah.

A further aspect of the invention pertains to a method of using said Li-ion battery described herein to supply power, said method comprising using a battery disclosed herein to supply voltage in the range of about 2 V to about 5 V. In some embodiments, said battery discharges at a voltage in the range of about 2 V to about 5 V, or discharges in the range of about 3 V to about 5 V, or discharges in the range of about 2.5 V to about 4.5 V, or discharges at about 4.5 V. In further embodiments of the invention, the charging or discharging of said battery takes place at an operational temperature in the range of about −60° C. to about 60° C.

### LIST OF EMBODIMENTS

The following is a list of non-limiting embodiments:
1. An electrolyte composition, said composition comprising a lithium salt dissolved in one or more solvents, wherein said solvent has a donor number <10, a dielectric constant >5, a boiling point greater than 60° C., and a melting point less than −60° C. The electrolyte composition may be a soft solvating electrolyte.
2. The electrolyte composition of embodiment 1, wherein the solvent is chosen from MDFA, MDFSA, M4FP, EDFA, TTE, and M3FP, or combinations thereof.
3. The electrolyte composition of embodiment 1, wherein the solvent is MDFA.
4. The electrolyte composition of embodiment 1, wherein the electrolyte comprises a mixture of MDFA and MDFSA.
5. The electrolyte composition of embodiment 4, wherein the electrolyte composition comprises MDFA, MDFSA and TTE.
6. The electrolyte composition of embodiment 3 or 4, wherein the electrolyte composition comprises about 20% to about 50% of MDFA.
7. The electrolyte composition of embodiment 4, wherein the composition comprises about 10% to about 25% MDFSA.
8. The electrolyte composition of embodiment 5, wherein the composition comprises about 30% to about 60% TTE.
9. The electrolyte composition of embodiment 5, wherein TTE comprises about 40% to about 60%, or about 40% to about 50% by volume of the electrolyte.
10. The electrolyte composition of embodiment 5, wherein the solvent volume ratio is 4:1:5 for MDFA, MDFSA, and TTE, respectively.
11. The electrolyte composition of embodiment 1, wherein the lithium salt is chosen from LiTFSI, LiClO₄, LiI, LiBF₄, LiCF₃SO₃, LiNO₃, LiBr, and LiCF₃CO₂, or combinations thereof.
12. The electrolyte composition of embodiment 1, wherein the lithium salt is LiTFSI.
13. The electrolyte composition of embodiment 1, wherein the lithium salt is present at a concentration in the range of about 0.5 M to about 4 M.
14. The electrolyte composition of embodiment 13, wherein the lithium salt is present at a concentration in the range of about 1 M to about 2 M.
15. The electrolyte composition of embodiment 13, wherein the concentration of lithium salt is about 1 M.
16. The electrolyte composition of embodiment 1, wherein the electrolyte comprises about 1 M of LiTFSI in about 4:about 1:about 5 volume ratio MDFA/MDFSA/TTE mixture.
17. A Li-ion battery, said battery comprising a cathode, an anode, and an electrolyte of any of the preceding embodiments.
18. The Li-ion battery of embodiment 17, wherein the cathode comprises NMC811.
19. The Li-ion battery of embodiment 17, wherein the cathode comprises NMC811, PVDF and carbon black.
20. The Li-ion battery of embodiment 19, wherein the cathode comprises about 80 wt % to about 98 wt % of said NMC811, about 1 wt % to about 10 wt % of said PVDF, and about 1 wt % to about 10 wt % of said carbon black.
21. The Li-ion battery of embodiment 20, wherein the cathode comprises about 90 wt % to about 95 wt % of said NMC811, about 3 wt % to about 5 wt % of said PVDF, and about 2 wt % to about 5 wt % of said carbon black.
22. The Li-ion battery of embodiment 20, wherein the cathode comprises about 90 wt % to about 95 wt % of said NMC811, about 2.5 wt % to about 5 wt % of said PVDF, and about 2.5 wt % to about 5 wt % of said carbon black.
23. The Li-ion battery of embodiment 20, wherein the cathode comprises about 94 wt % NMC811, about 3 wt % PVDF, and about 3 wt % carbon black.
24. The Li-ion battery of embodiment 17, wherein the anode comprises graphite.
25. The Li-ion battery of embodiment 17, wherein the anode comprises graphite, PVDF and carbon black.
26. The Li-ion battery of embodiment 25, wherein the anode comprises about 80 wt % to about 98 wt % of said graphite, about 1 wt % to about 10 wt % of said PVDF, and about 1 wt % to about 10 wt % of said carbon black.
27. The Li-ion battery of embodiment 25, wherein the anode comprises about 90 wt % to about 95 wt % of said graphite, about 4 wt % to about 7 wt % of said PVDF, and about 1 wt % to about 3 wt % of said carbon black.
28. The Li-ion battery of embodiment 17, wherein the anode comprises about 90 wt % to about 95 wt % of said graphite, about 3 wt % to about 5 wt % of said PVDF, and about 2 wt % to about 5 wt % of said carbon black.
29. The Li-ion battery of embodiment 17, wherein the anode comprises about 92 wt % of said graphite, 6 wt % of said PVDF, and 2 wt % of said carbon black.
30. The Li-ion battery of embodiment 17, wherein said battery has an operational charging and discharging temperature in the range of about −120° C. to about 120° C., or about −90° C. to about 90° C., or about −60° C. to about 60° C., or about −30° C. to about 30° C. . . .
31. The Li-ion battery of embodiment 30, wherein the operational charging and discharging temperature of said battery is in the range of about −40° C. to about 50° C.
32. The battery of any of the preceding embodiments, wherein the battery is a coin cell type battery.
33. The battery of any of the preceding embodiments, wherein the cathode is coated on Al foil.
34. The battery of any of the preceding embodiments, wherein the anode is coated on Cu foil.
35. The battery of any of the preceding embodiments, wherein the battery is a pouch cell type battery.
36. The battery of embodiment 17, wherein the cathode is attached via electrode tabs to an aluminum strip.
37. The battery of embodiment 17, wherein the anode is attached via electrode tabs to a nickel strip.
38. The battery of embodiment 17, wherein the separator material is CELGARD 2325®, CELGARD 35018, CELGARD 25008, or CELGARD pp 1410®.
39. The battery of embodiment 17, wherein said electrolyte is present in an amount in the range of about 20 μL to about 80 μL, or about 30 μL to about 70 μL, or about 40 μL to about 60 μL for a coin cell type battery.
40. The battery of embodiment 17, wherein said electrolyte is present in the range of about 2 g/Ah to about 8 g/Ah, or about 2.5 g/Ah to about 6.5 g/Ah, or about 3 g/Ah to about 5 g/Ah for a pouch cell type battery.
41. A method of assembling a Li-ion battery of any of the preceding embodiments, said method comprising layering of a cathode any of the preceding embodiments, a separator material, an anode of any of the preceding embodiments, and a electrolyte composition of any of the preceding embodiments.
42. The method of any of the preceding embodiments, wherein the battery is a coin cell type battery.
43. The method of any of the preceding embodiments, wherein the cathode is coated on Al foil.
44. The method of any of the preceding embodiments, wherein the anode is coated on Cu foil.
45. The method of any of the preceding embodiments, wherein the battery is a pouch cell type battery.
46. The method of embodiment 32, wherein the cathode is attached via electrode tabs to an aluminum strip.
47. The method of embodiment 32, wherein the anode is attached via electrode tabs to a nickel strip.
48. The method of embodiment 32, wherein the separator material can be CELGARD 2325®, CELGARD 3501°, CELGARD 2500®, or CELGARD pp 1410®
49. The method of embodiment 32, wherein said electrolyte is present in an amount in the range of about 20 μL to about 80 L, or about 30 μL to about 70 μL, or about 40 μL to about 60 μL for a coin cell type battery.
50. The method of embodiment 32, wherein said electrolyte is present in the range of about 2 g/Ah to about 8 g/Ah, or about 2.5 g/Ah to about 6.5 g/Ah, or about 3 g/Ah to about 5 g/Ah for a pouch cell type battery.
51. A method of using a battery of any of the preceding embodiments to supply power, said method comprising using a battery of any of the preceding embodiments to generate the flow of current and electricity such that the battery charges or discharges, wherein the battery discharges at a voltage in the range of about 2 V to about 5 V.
52. The method of any of the preceding embodiments, wherein the discharge voltage may be in the range of about 3 V to about 5 V.
53. The method of any of the preceding embodiments, wherein the discharge voltage may be in the range of about 2.5 to about 4.5 V.
54. The method of any of the preceding embodiments, wherein the discharge voltage may be about 4.5 V.
55. The method of any of the preceding embodiments, wherein the charging or discharging of the battery may be operational at temperatures in the range of about −60° C. to about 60° C.

### 3.0 Examples

The following examples are provided solely to illustrate the present invention and are not intended to limit the scope of the invention, described herein.

### Example 1. Balanced Electrolyte Design Principle

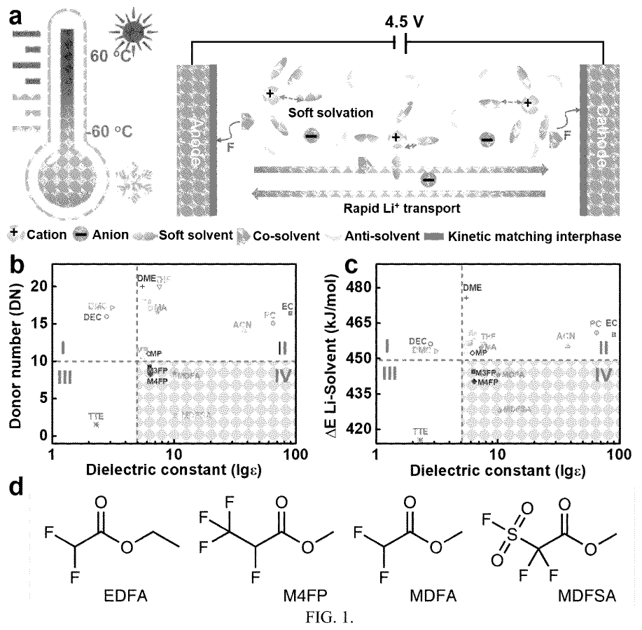

Low freezing point but a moderate boiling point and a wide electrochemical stability window set the primary criteria for solvent selection (Table 1), while the secondary criteria should be a soft solvating ability that ensures a low Li⁺ ion desolvation energy with little sacrificing ionic dissociation ability (FIG. 1A). The DN and Li⁺-solvent binding energy from density functional theory (DFT) calculations reveal a close correlation between them (FIG. 1B-C), making DFT a useful method for screening solvating ability. Inclusion of cross interactions and steric hindrance between solvates in the Li⁺ first solvation shell results in a similar picture as shown in FIG. 12. Other parameters such as BF₃ affinity and Li cation basicity of various solvents are listed in Table 2, demonstrating a similar trend. Among those, DN is the most widely used and available physical parameter. Therefore, DN should serve as a primary descriptor to evaluate the lithium solvating ability. Most known polar solvents with high salt dissociating ability have a high donor number (DN>10) (zone I and II in FIG. 1B) while those with low DN and low dielectric constant have a poor salt dissociating ability (zone III in FIG. 1B-C), representing non-solvating diluents. However, there appears to be a balanced region (zone IV) comprising low-DN solvents with moderate dielectric constants which lead to modest Li⁺-solvent binding energies and salt dissociation.

TABLE 1
Physical properties of organic solvents used for low-temperature batteries.

| | | Relative | Tₘ | T_{b} | Electrochemical | |
|---|---|---|---|---|---|---|
| Solvent | DN | dielectric | (° C.) | (° C.) | Window (V) | Ref |
| Diethyl ether | 19.2 | 4.3 | −117 | 35 | <4.0 | [10] |
| Ethyl acetate | 17.1 | 6.0 | −84 | 77 | 1.5~4.7 | [8] |
| Methyl | 11.0 | 6.2 | −88 | 79 | <4.3 | [20] |
| propionate | | | | | | |
| EDFA | 9.0 | 9.2 | <−90 | 99.2 | <4.3 | This work |
| MDFA | 8.4 | 10.1 | <−90 | 86 | <5.0 | This work |
| M4FP | 6.3 | 8.3 | −42 | 95 | <4.8 | This work |
| Difluoromethane | <1.0 | 14.2 | −136 | −52 | <5.0 | [9] |

Relative dielectric and DN values (in boldface) are determined from capacitance measurements and calorimetry, respectively.

TABLE 2
Comparison of different physical parameters
of various organic solvents

| | Donor | Dielectric | | |
|---|---|---|---|---|
| | number | constant | BF₃ | Li cation |
| Solvent | (DN) | (ε) | affinity | basicity |
| Ethylene Carbonate (EC) | 16.4 | 90.1 | 66.4 | / |
| Propylene Carbonate (PC) | 15.1 | 64.9 | 64.2 | / |
| Acetonitrile (CH₃CN) | 14.1 | 37.5 | 60.4 | 142.1 |
| Tetrahydrofuran (THF) | 20.0 | 7.6 | 90.4 | 137.2 |
| 1,2-dimethoxyethane | 20 | 5.5 | 74.7 | 187.9 |
| (DME) | | | | |
| Diethyl ether (DEE) | 19.2 | 4.3 | 78.8 | 139.7 |
| Dimethyl Carbonate | 17.2 | 3.1 | 67.6 | 155.0 |
| (DMC) | | | | |
| Diethyl Carbonate (DEC) | 16.0 | 2.8 | 71.0 | / |
| 1,4-Dioxane | 14.8 | 2.3 | 74.1 | 127.0 |
| Ethyl acetate (EA) | 17.1 | 6.4 | 75.6 | 150.8 |
| Methyl acetate (MA) | 16.5 | 7.3 | 72.8 | 147.4 |
| Methyl propionate (MP) | 11.0 | 6.2 | / | 151.9 |

Applying these two criteria to a number of solvents (FIG. 1A-C), a family of fluorinated esters (EDFA, M4FP, MDFA, and MDFSA) were identified as prime candidates. The chemical structures of these species are illustrated in FIG. 1D. One of the zone IV solvents methyl (3,3,3-trifluoropionate) (M3FP) has previously shown promising results in Li metal batteries under a low temperature of −60° C., providing additional support for the proposed criteria. Compared against non-fluorinated ester solvents, the fluorinated counterparts (MDFA, EDFA, M4FP) possess a wider electrochemical stability window, greater thermal stability, and ultra-low freezing points (Table 1).

To maximize ionic conductivity, soft solvents need to be coupled with highly dissociating and solvable lithium salt. A study of (glyme)-LiX electrolytes showed that salt dissociation follows the order: LiTFSI>LiClO₄, LiI>LiBF₄>LiCF₃SO₃>LiNO₃, LiBr>LiCF₃CO₂, which is consistent with the DN values of some of the anions (TFSI⁻, 5.4; CF₃SO₃⁻, 16.9; Br⁻, 33.7). LiTFSI is a good choice due to a weak Li⁺ binding energy and a high solubility of 5.0, 4.5, 3.0 M in MDFA, EDFA, M4FP solvents, respectively.

Soft solvating solvents also promote the formation of a LiF-rich SEI and CEI due to the high reduction potentials observed in DFT screening of the solvent and Li⁺-solvent complexes (see Example 10). These solvents intrinsically favor the formation of prevailing ion pairs and aggregates in the solution, which is beneficial for forming anion-derived LiF-rich interphases. MDFSA (fluorosulfonyl substituted MDFA, molecular structure displayed in FIG. 1D) with a high reduction potential of 2.2 V was added as a co-solvent to further (1) reduce the solvation degree of Li⁺ and (2) enhance the formation of LiF-rich SEI and LiF-rich CEI. The addition of TTE diluent renders the electrolyte non-flammable when the volume ratio of TTE in the mixture solvent exceeds 40%.

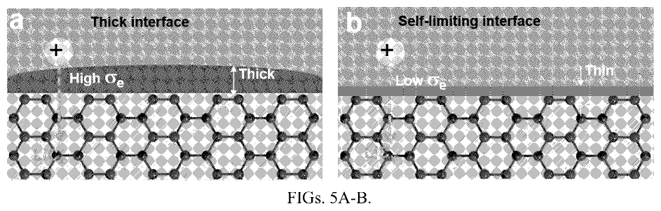

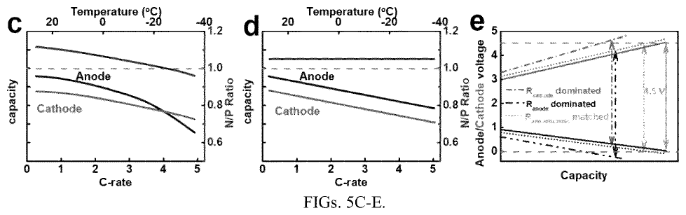

Both the graphite anode and NMC811 cathode experience relatively small volume change during lithiation/delithiation, which can be tolerated by the elastic inorganic-organic interphase, leading to excellent cycle life (FIG. 5). Since organic interphase has higher activation energy, higher electronic conductivity, higher solubility in electrolyte, and lower high-voltage stability than LiF, it is still desirable to minimize the organic content in the interphase. Increasing the LiF content is expected to reduce the thickness of the SEI during its self-limiting formation process leading to lower area-specific resistance even at a low temperature (FIG. 5B). The similar LiF-rich compositions of both SEI and CEI also improve the overpotential and capacity and kinetics matching between the graphite anode and NMC811 cathode at different currents and temperatures (FIG. 5D), allowing maximum cell capacity and Li⁰ plating prevention by controlling the cell voltage (FIG. 5E). In comparison, the inorganic-organic SEI/CEI formed in conventional carbonate electrolytes results in mismatched capacities and overpotentials between the anode and cathode (FIG. 5C), thus affecting the high rate and low-temperature performance of the full cells. Balancing the thermodynamic (capacity) and kinetic (interface resistance) matching between the graphite anode and NMC811 cathode effectively suppresses Li⁰ plating during fast-charging at room-temperature and operation at low temperatures. The high-modulus, lithiophobic LiF-rich interphases mitigate lithium dendrite growth even if local Li⁰ plating happens under extreme conditions.

### Example 2. Physicochemical Properties and Solvation Structure

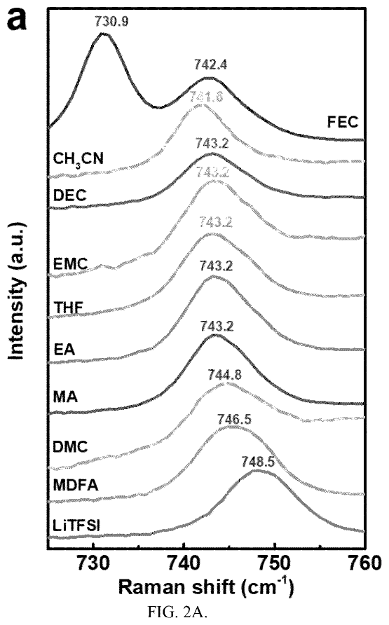

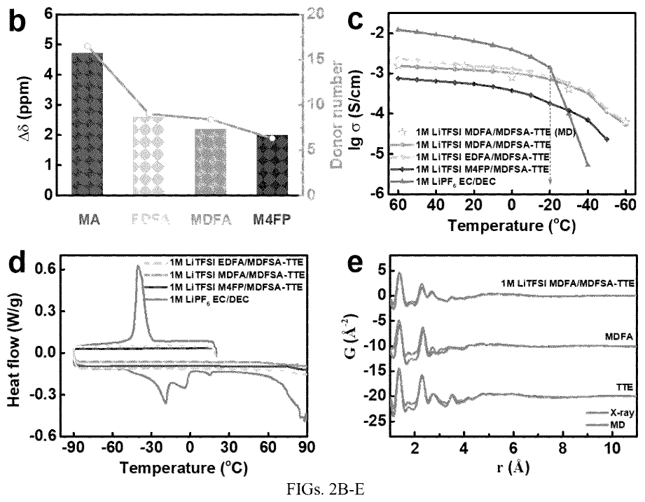

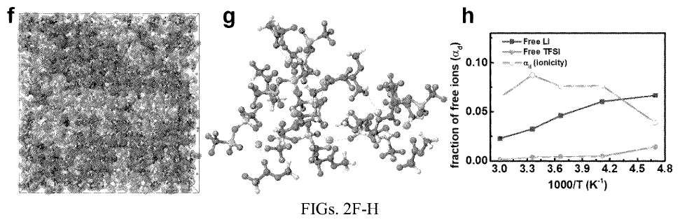

After dissolving LiTFSI into different solvents, the TFSI⁻ . . . . Li⁺ coordination was characterized using Raman spectroscopy. Among all the electrolytes with commonly used solvents, the TFSI-anion peak corresponding to S—N—S bending/vibration in 1 M LiTFSI-MDFA electrolyte produces the smallest redshift (2 cm⁻¹, FIG. 2A) when referenced against crystalline LiTFSI (748.5 cm⁻¹), indicating that MDFA has the lowest solvation ability. The increase of LiTFSI salt concentration and addition of TTE further reduce the Li⁺-solvent coordination, resulting in higher population of ionic aggregation. Because some solvents can only dissolve LiFSI salt, Raman spectra of 1M LiFSI in different solvents were also compared in FIG. 15B, which shows a similar trend as 1M LiTFSI. When LiFSI is dissolved in the MDFA solvent, the S—N—S bending peak in the LiFSI crystal at 774.5 cm⁻¹ experiences the smallest shift to 750.1 cm⁻¹, suggesting a smaller Li⁺-solvent binding energy than all reported weakly solvating solvents (diethyl ether, 1,4-dioxane).

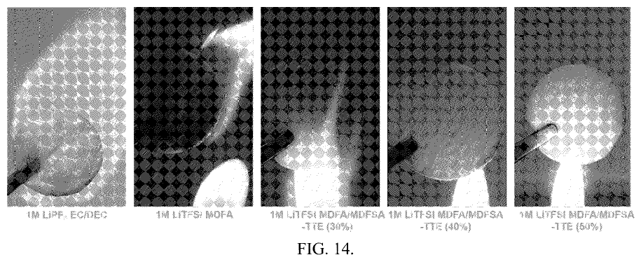

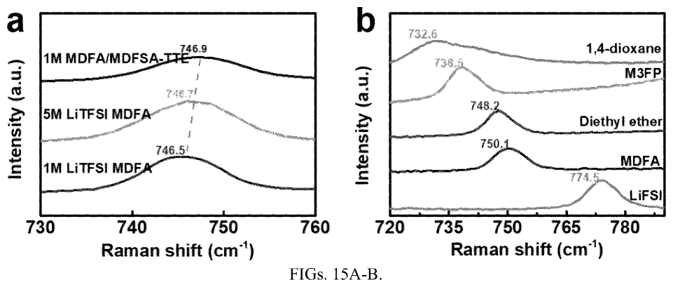

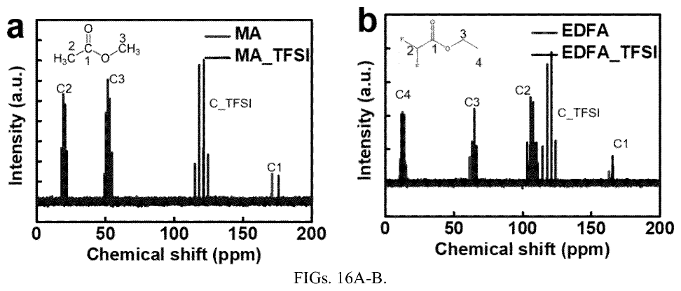

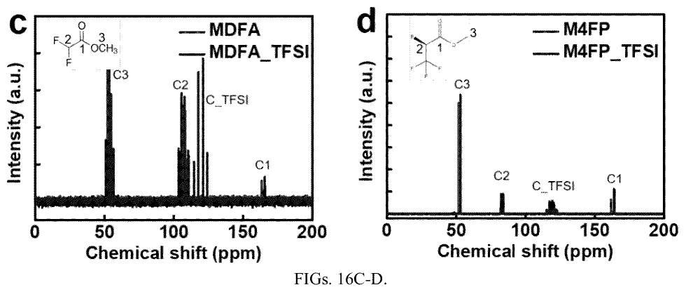

The solvation structures of the electrolytes with different solvents (MA, EDFA, MDFA, M4FP) were also investigated using nuclear magnetic resonance (NMR). The chemical shift of carbonyl (C═O) carbons of solvent in the presence of LiTFSI salt is referenced against its corresponding pure solvent, and the difference is denoted as Δδ (Δδ=δ_{Li, Solvent}−δ_{Solvent}), where δ_{Li, Solvent} and δ_{Solvent} represent the corresponding chemical shifts in LiTFSI saturated electrolytes and the neat solvent, respectively. All carbonyl ¹³C expectedly undergo an upshift with the addition of LiTFSI salt due to the better shielding caused by Li⁺-solvent interaction. The detailed ¹³C and ¹⁷O NMR spectra are presented in FIGS. 16-17. A similar trend in chemical shift is also observed in ¹⁷O NMR spectra in the sequence of M4FP<MDFA<EDFA. The smallest Δδ of 2.0 ppm for M4FP (FIG. 2B) is directly related to the weakest Li⁺-solvent interaction, consistent with the DN value.

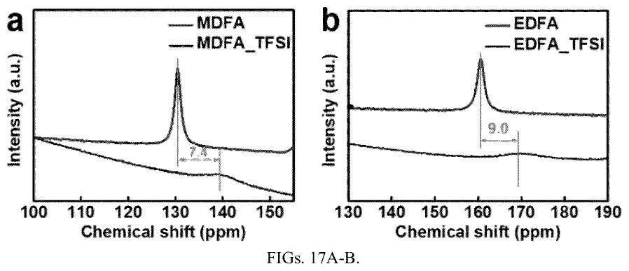

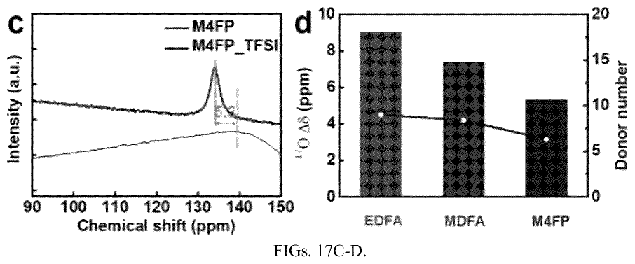

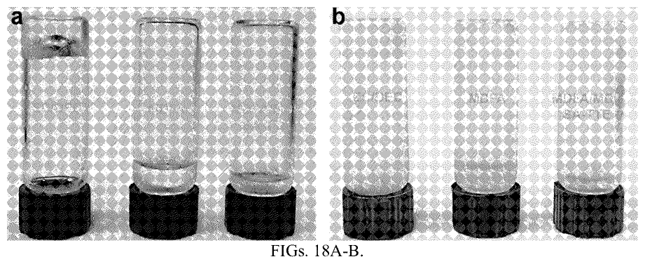

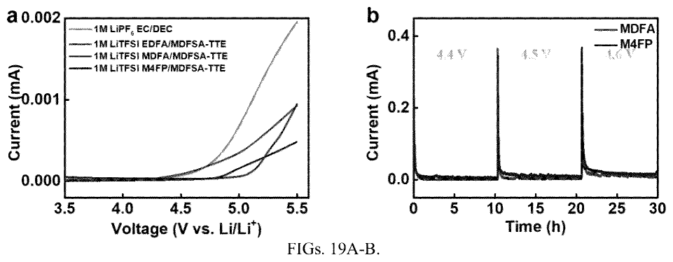

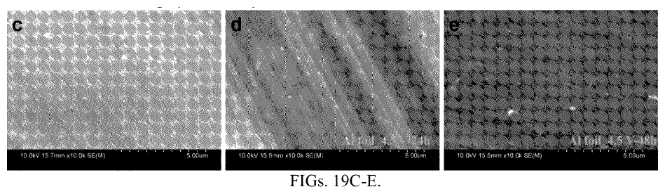

The ionic conductivity of the prepared soft electrolytes was summarized in FIG. 2C. As expected, the ionic conductivity is the lowest for the M4FP-based electrolyte as it has the lowest DN and dielectric constant. At 20° C., the ionic conductivities of the proposed soft electrolytes are 1.8 mS/cm for EDFA, 1.7 mS/cm for MDFA, and 0.6 mS/cm for M4FP, which are slightly lower than that of EC/DEC electrolyte (6.4 mS/cm). However, at temperatures below −20° C., the ionic conductivities of MDFA-based electrolytes outperform that of EC/DEC electrolytes (FIG. 2C). The sudden drop in the ionic conductivity of EC/DEC electrolyte around −20° C. is due to solidification of the electrolyte. This phase transition of the EC/DEC electrolyte was identified through differential scanning calorimetry (DSC) (FIG. 2D), exhibiting two observable endothermic peaks around −4.0 and −18.6° C. DSC also demonstrated that none of the soft solvent-based electrolytes undergo a phase change over the temperature range of −90° C. to ±90° C. These DSC results are supported by visual observation of the electrolytes upon storage at −30° C. and −90° C., respectively. EC/DEC electrolyte was found to freeze under −30° C. (FIG. 18A), whereas MDFA-based electrolytes maintain liquid state even when the storage temperature is as low as −90° C. (FIG. 18B). The electrolyte oxidation potential for the designed 1M LiTFSI MDFA/MDFSA-TTE and 1M LiTFSI M4FP/MDFSA-TTE electrolytes is >4.8 V (FIG. 19A), which allows the NMC811 cathode to operate at 4.5 V. As for 1M LiTFSI EDFA/MDFSA-TTE electrolyte, the oxidation current starts to increase sharply at 4.3 V, indicating it is not suitable for high-voltage operation. The more aggressive floating tests further confirmed the high stability of the designed electrolytes at high voltages. At 4.5 V or 4.6 V, the minimal leakage current of 1 M LiTFSI MDFA/MDFSA-TTE electrolyte is smaller than that of 1 M LiTFSI M4FP/MDFSA-TTE electrolyte (FIG. 19B). In addition, 1 M LiTFSI MDFA/MDFSA-TTE electrolyte showed high inhibition of aluminum corrosion due to the formation of the surface layer (FIGS. 19C-E). Taking all the above factors including Li⁺-solvent binding energy, ionic conductivity, and electrochemical stability window into account, 1M LiTFSI MDFA/MDFSA-TTE soft electrolyte is selected for further study.

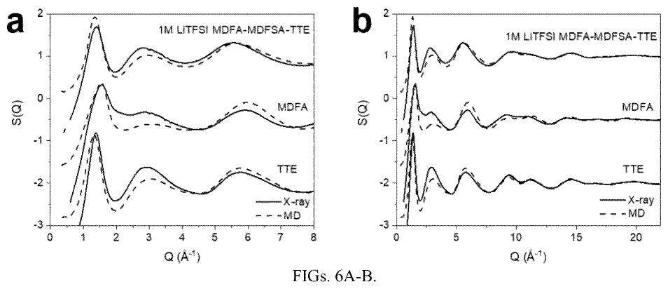

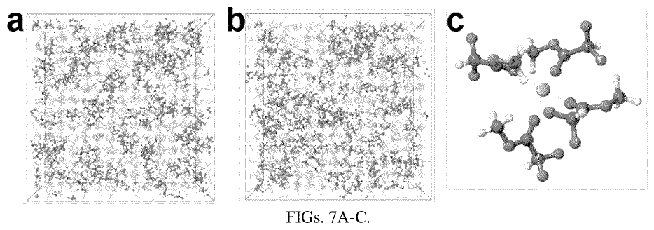

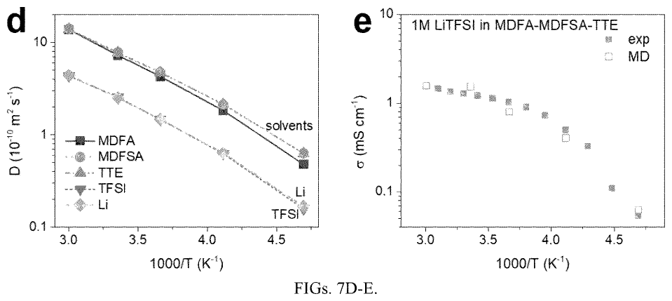

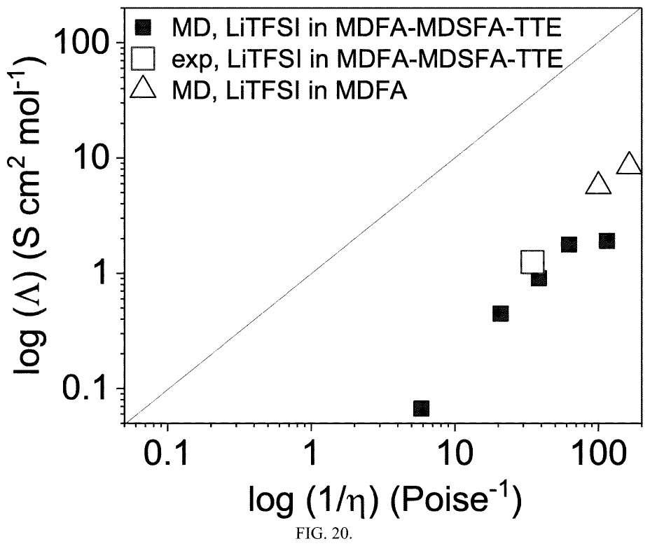

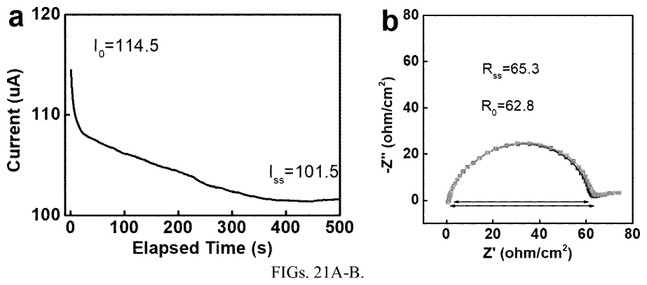

The solvation structure of 1M LiTFSI MDFA/MDFSA-TTE electrolyte was further analyzed using X-ray pair distribution function (PDF). The experimental results agreed well with molecular dynamics (MD) simulations both in R space (FIG. 2E) and Q space (FIG. 6), validating the MD simulation predictions of the electrolyte structure. Snapshots of MD simulation boxes (FIG. 2F and FIGS. 7A-B) indicate that the addition of TTE and MDFA promotes ion aggregation. In the mixed MDFA/MDFSA-TTE solvent electrolyte, the Li⁺ are primarily coordinated by 1.92 MDFA and 1.66 TFSI⁻ anions with a minor contribution of 0.09 from MDFSA (FIG. 2G). Free Li⁺-ions solvent separated from TFSI⁻ are primarily coordinated by 4 MDFA (FIG. 7C). In 1M LiTFSI in MDFA, 10% of free Li⁺ and 3% of free TFSI⁻ were observed at room temperature. Dilution with TTE and MDFSA decreased the fraction of free Li⁺ to 2-7% depending on temperature, while the fraction of free TFSI⁻ was below 0.4% indicating that nearly all TFSI-anions are participating in aggregates (FIG. 2F), which is consistent with the Walden plot trend (FIG. 20) and preferential Li⁺ vs. TFSI-transport as evidenced by high Li⁺ transference number (t+). Accordingly, 1M LiTFSI MDFA/MDFSA-TTE electrolyte also has a high t₊ of 0.73 (FIG. 21). Decreasing temperature slightly increases the fraction of free Li⁺ while ionicity (inverse Haven ratio) stays approximately the same and even slightly decreases below −30° C. (FIG. 2H), resulting in a more pronounced decrease of conductivity in this region (FIG. 7D-E).

### Example 3. Electrochemical Performance of 4.5 V NMC811∥Graphite Full Cells

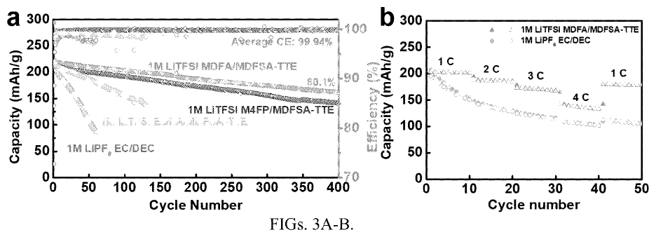

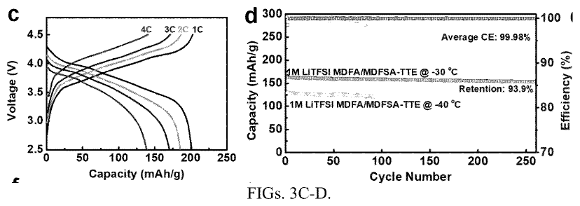

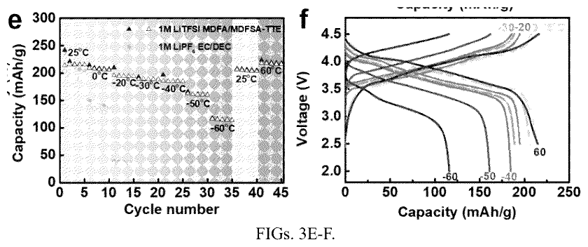

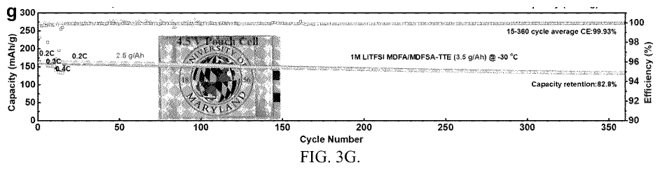

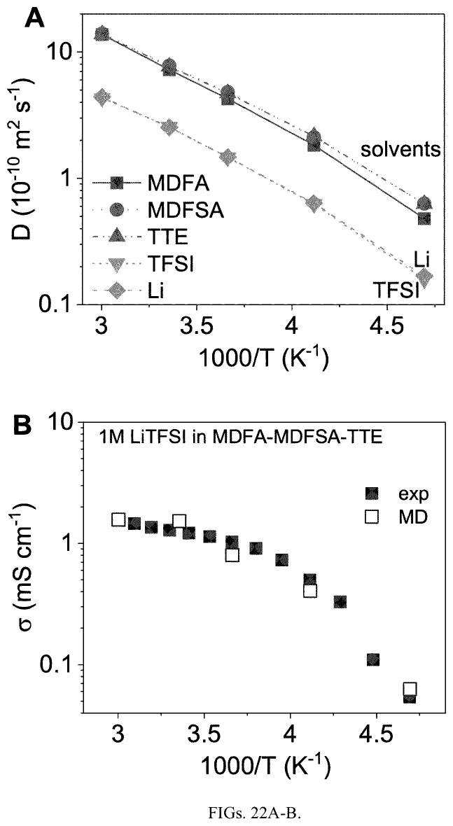

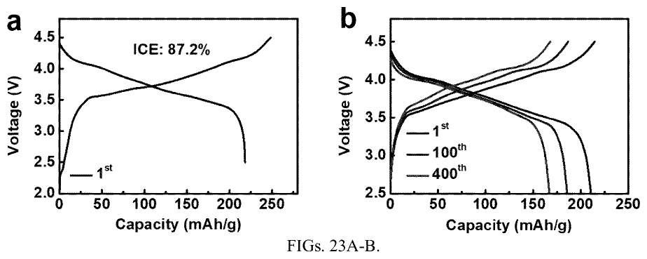

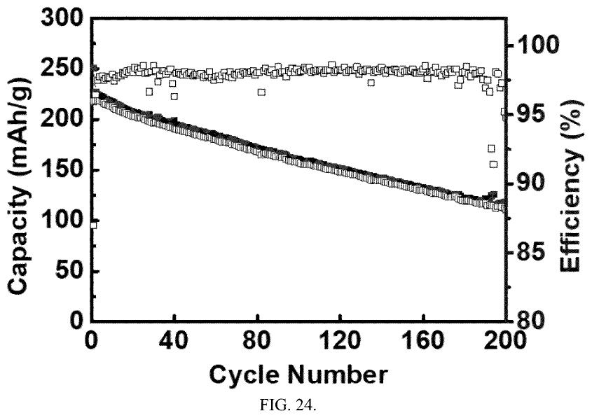

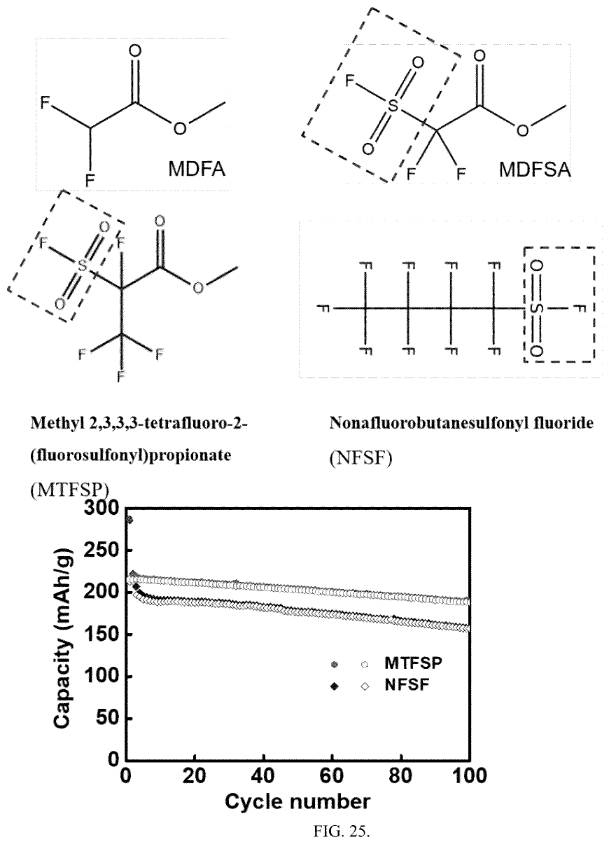

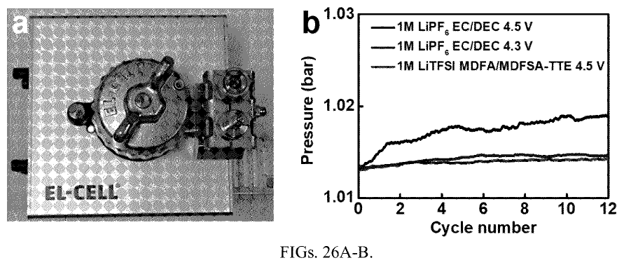

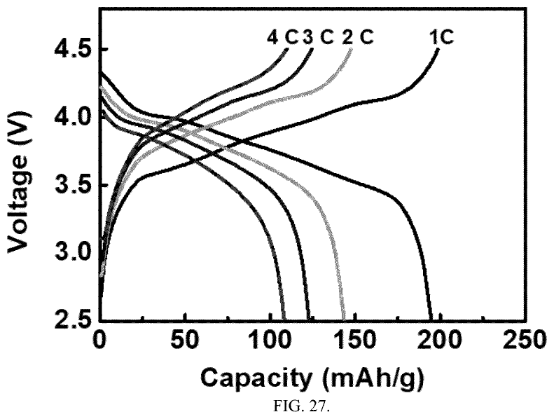

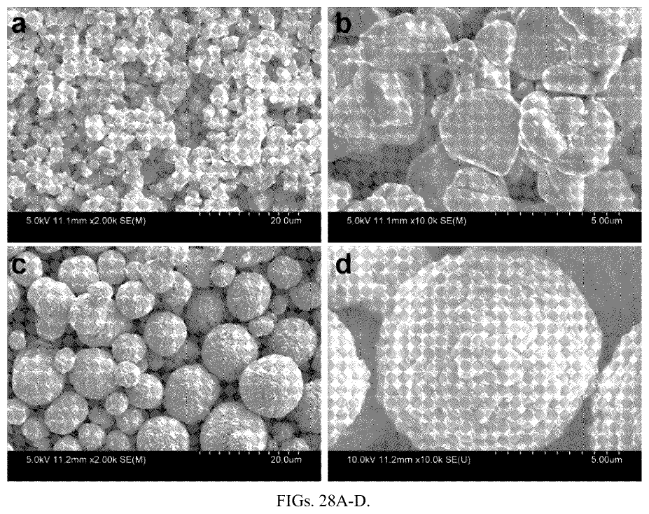

The cycling performance and rate capability of NMC811∥graphite full cells with an areal capacity of 2.5 mAh cm⁻² and N/P ratio of 1.1 in different electrolytes were examined in the voltage range of 2.5-4.5 V. FIG. 3A shows that the performance of full cells in the 1M LiTFSI MDFA/MDFSA-TTE electrolytes outperform EC/DEC-based electrolyte. Specifically, the full cell in 1M LiTFSI MDFA/MDFSA-TTE electrolyte shows a capacity retention of 80.1% after 400 cycles with an average CE of 99.94%. The first charge/discharge formation cycle of NMC811∥graphite full cells at 0.2 C shows a high initial CE of 87.2% (FIG. 23A). The voltage profiles of NMC811∥graphite full cells in the 1st, 100th, and 400th cycles at 0.5 C can be found in FIG. 23B. In comparison, the full cell with 1M LiTFSI MDFA-TTE in FIG. 24 demonstrates faster capacity decay (52.8% retention after 200 cycles), verifying the role of MDFA co-solvent in forming the LiF-rich interphases and thus stabilizing cycling performance. Stable cycling performance can also be achieved using other co-solvents with fluorosulfonyl functional groups (FIG. 25), suggesting that this is a universal strategy. In addition, the possible gas pressure changes of NMC811∥graphite full cells during charging/discharging cycles in 1M LiTFSI MDFA/MDFSA-TTE and 1.0 M LiPF₆ EC/DEC were simultaneously monitored by EL-Cell device. The pressure change in 1M LiTFSI MDFA/MDFSA-TTE electrolyte is almost negligible compared to the increased pressure in EC/DEC-based electrolyte under a high cutoff voltage of 4.5 V (FIG. 26).

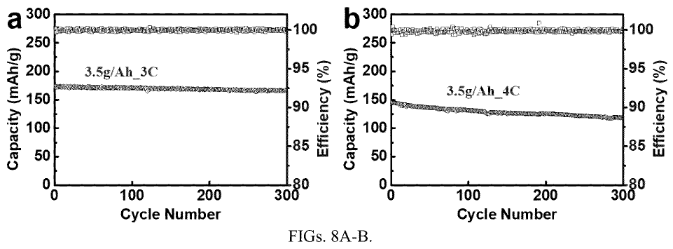

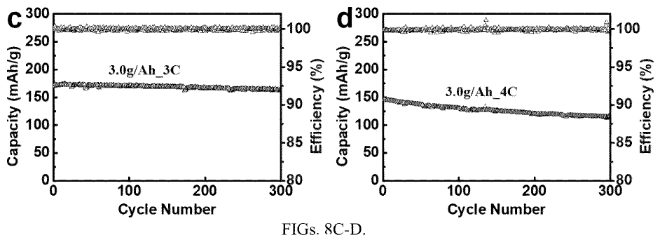

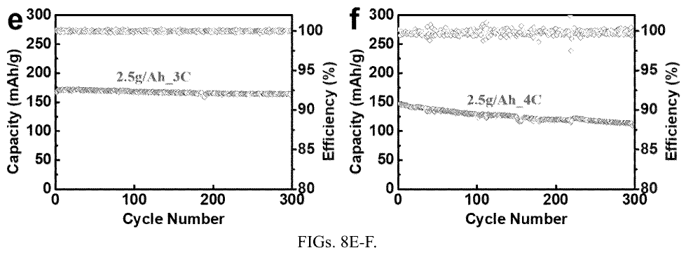

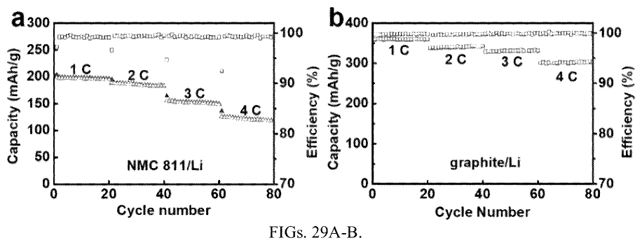

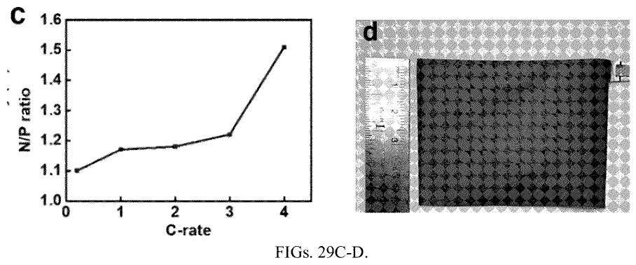

Improvements in rate performance over 1 M LiPF₆ EC/DEC are shown in FIG. 3B for NMC811∥graphite full cells with the 1M LiTFSI MDFA/MDFSA-TTE electrolyte, delivering a capacity of 202 mAh/g at 1 C, 185 mAh/g at 2 C, 169 mAh/g at 3 C, and 140 mAh/g at 4 C. The corresponding charge/discharge voltage profiles of the cells at different C-rates with 1M LiTFSI MDFA/MDFSA-TTE are shown in FIG. 3C. The rate performance is further improved by adopting polycrystalline NMC811, demonstrating stable cycling performance of NMC811∥graphite pouch cells with lean electrolytes at a high rate of 3-4 C (FIG. 8). Moreover, capacity is matched between the graphite anode and NMC811 cathode at different C-rates. The capacities of NMC811 cathode (FIG. 29A) and graphite anode (FIG. 29B) measured separately in half-cells using Li counter electrode ensure a N/P ratio to be slightly larger than 1 when C-rate increase from 1 C to 4 C (FIG. 29C), which effectively avoided lithium plating. The photo of the graphite anode from the dissembled pouch cell cycled under −30° C. also confirmed no obvious lithium plating on graphite anodes (FIG. 29D). This superior rate capability is attributed to the rapid Li⁺ diffusion across the LiF-rich interphases both on anodes and cathodes, low Li⁺ desolvation energy induced by the unique solvation structure, as well as high transference number of the designed electrolytes.

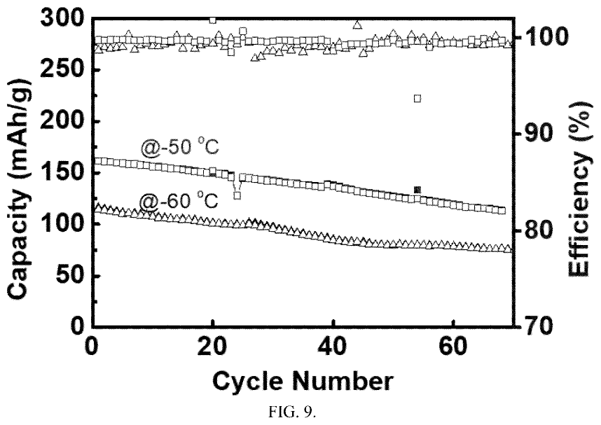

In addition to the excellent performance at room temperature, NMC811∥graphite full cells also exhibited exceptional performance at low temperatures. FIG. 3D shows the cycling stability of NMC811∥graphite full cells with 1M LiTFSI MDFA/MDFSA-TTE electrolytes at 0.2 C at −30° C. and −40° C. At −30° C., 93.9% of capacity is retained after 260 cycles with an average Coulombic efficiency of 99.98%. At lower temperatures down to −50/−60° C., a slightly faster capacity decay is observed (FIG. 9). FIG. 3E compared the performance of NMC811∥graphite full cells in two electrolytes at different temperatures. The NMC811∥graphite full cells with the EC/DEC electrolyte fail to operate at −30° C. due to the solidification of the electrolyte. In contrast, the capacity of the NMC811∥graphite full cell with 1M MDFA/MDFSA-TTE electrolyte shows high retention of their room temperature capacity at low-temperature: 206.8 (95%), 194.5 (90%), 188.7 (87%), 184.6 (85%), 161.0 (75%), and 115.5 (54%) mAh/g when cycled at 0° C., −20° C., −30° C., −40° C., −50° C., and −60° C., respectively. Representative voltage curves of full cells with 1M LiTFSI MDFA/MDFSA-TTE electrolyte at different temperatures are shown in FIG. 3F. NMC811∥graphite full cells with 1M MDFA/MDFSA-TTE electrolyte can fully restore their original capacity at 25° C. even after ultra-low temperature operation at −60° C., suggesting LiF-rich interphases are robust enough to mitigate Li⁰ plating and dendrites.

To better represent practical conditions, NMC811∥graphite pouch cells were evaluated (FIG. 3G) and delivered a charge/discharge capacity of 160.2 mAh/g at 0.2 C under −30° C., which is similar to that of coin cells under the same conditions. No obvious capacity decay is observed even with a lean electrolyte of 2.5 g/Ah (FIG. 3G). At higher C-rates of 0.4 C and 0.5 C, the pouch cell shows capacities of 152.6 mAh/g, 134.6 mAh/g, respectively. NMC811∥graphite pouch cells maintained 80% capacity after 360 cycles. Conducting both the charging and discharging test of the pouch cell at the same low temperature is a very aggressive protocol, especially at very low temperatures with normal 0.2-0.3 C rates. In previous reports in the literature, almost all full cells using graphite anodes were charged at room temperature first and then discharged at low temperatures to achieve high charge capacity and avoid Li plating. A few electrolytes enabling Li metal batteries can be charged/discharged at low temperature, but they cannot support the high voltage NMC811 cathodes. To date, it is still impossible to charge/discharge NMC811∥graphite full cells with practical areal capacity and N/P ratio. However, the inventors surprisingly found that by using rational design of advanced electrolytes, the exceptional performance of NMC811∥graphite full cells in both coin cell and pouch cell formats with the most aggressive protocol of charging/discharging at the same low temperature even at −60° C. could be demonstrated. A quantitative comparison of the Li-ion batteries using graphite anodes but different cathodes under practical applications (areal capacity, working voltage, operation temperature range, low-temperature charge capacity, rate capability, and safety) are listed in Table 3.

TABLE 3
Comparison of relevant Li-ion batteries employing graphite anodes for extreme batteries.

| | | | | Low- | Low- | | | |
|---|---|---|---|---|---|---|---|---|
| | Cathode | | Operation | temperature | temperature | | | |
| | (loading | Voltage | temperature | discharge | charge | C- | | |
| Electrolyte | mAh/cm²) | (V) | (° C.) | capacity | capacity | rate | safety | ref |
| 1.0M | LiNi_{0.8}Co_{0.2}O₂(4) | 4.2 | −60~+50 | 40%(−60° C.) | unable | 1 C | moderate | [6] |
| LiPF₆ EC + | | | | | | | | |
| EMC + | | | | | | | | |
| MP | | | | | | | | |
| 20:60:20 | | | | | | | | |
| vol. %. | | | | | | | | |
| 1.4M | NMC811(2.8) | 4.4 | −40~+60 | 46.2%(−40) | unable | 3 C | Good | [7] |
| LiFSI | | | | | | | | |
| DMC-EC- | | | | | | | | |
| TTE | | | | | | | | |
| 1M LiPF₆ | NMC811(1.5) | 4.3 | −40~+45 | 60%(−40) | 60%(−40) | 5 C | moderate | [8] |
| MP-FEC | | | | | | | | |
| 90:10 vol. | | | | | | | | |
| % | | | | | | | | |
| MDFA- | NMC811(2.5) | 4.5 | −60~+60 | 75%(−50) | 75%(−50) | 4 C | excellent | This |
| based | | | | 54%(−60) | 54%(−60) | | | work |

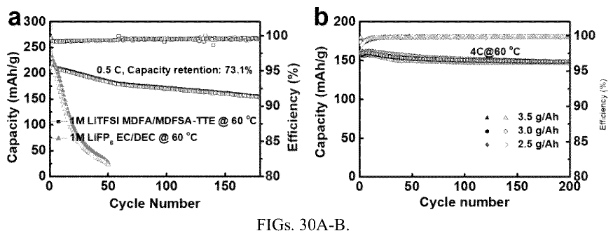

In addition to exceptional low-temperature performance, 1M MDFA/MDFSA-TTE electrolyte also demonstrated that NMC811∥graphite full cells achieved an improved capacity at a high temperature since the formed LiF-rich SEI and CEI are less soluble in the electrolyte. As shown in FIG. 30A, the NMC811∥graphite full cell with 1M LiTFSI MDFA/MDFSA-TTE electrolyte maintains 73.1% of capacity after 180 cycles at 60° C. Remarkably, the NMC811∥graphite pouch cell with lean electrolyte (2.5 g/Ah) retains 92% after 200 cycles at 4 C under 60° C. (FIG. 30B). In contrast, the capacity of NMC811∥graphite full cell with EC/DEC-based electrolyte decays rapidly at 60° C. The high working voltage up to 4.6 V vs. Li/Li⁺ is beyond not only the stability limits of the EC/DEC-based electrolyte but also the organic-rich SEI/CEI at elevated temperatures, especially in the presence of LiPF₆.

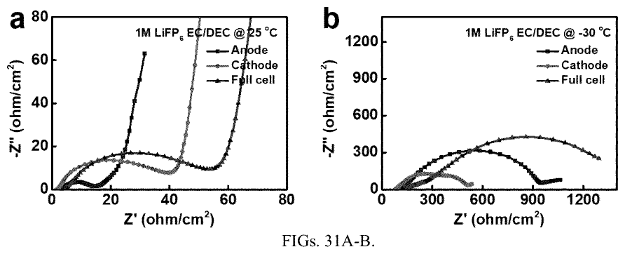

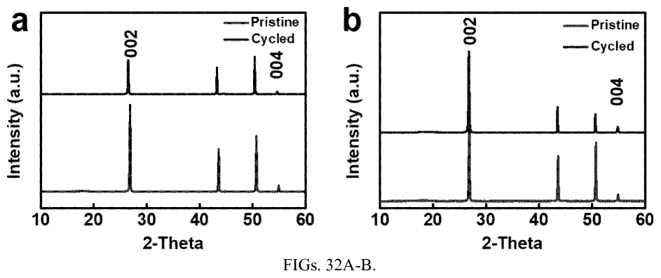

To quantitatively analyze the improved low-temperature performance, three-electrode pouch cells were used to simultaneously monitor the behavior of the anode and cathode (FIG. 10A), in which the cell's voltage (U), NMC811 cathodes' potential (E₍₊₎), and graphite anodes' potential (E₍₋₎) were simultaneously monitored. It is found that the potential of the graphite anode never fell below 0 V vs. Li/Li⁺ even at −30° C. (FIG. 10B), indicating a low overpotential at the anode and the consequent absence of lithium plating. This is partially ascribed to the similar impedance between NMC811 cathode and graphite anodes at 25° C. (FIG. 10C) and at −30° C. (FIG. 10D). When the temperature is decreased from 25° C. to −30° C., the SEI resistance R_{SEI} and charge transfer resistance R_{ct} of both the cathode and anode increase. The resistances of SEI and charge transfer for cathode and anode (R_{SEI}, cathode=4.8, R_{SEI}, anode=5.6, R_{ct}, cathode=22.5, R_{ct}, anode=25.2) at 25° C. increased to R_{SEI cathode}=72.3, R_{SEI anode}=81.5; R_{ct cathode}=228.5, R_{ct anode}=241.2 at −30° C. (FIG. 10). The nearly identical impedance values of the cathode and anode at different temperatures indicate that impedance matching was successfully achieved via tailoring the interphasial chemistry. In sharp contrast, the overall resistances of cells, and especially R_{ct}, in EC/DEC electrolytes increased when temperature drops from 25° C. to −30° C. (FIG. 31) due to the solidification of the electrolyte and the slowed down kinetics across the interphases. In addition, the impedance ratio between NMC811 cathode to graphite anode also largely changed from NMC811 impedance dominating at 25° C. to graphite anode impedance dominating at −30° C.

### Example 4. Characterization of the Electrodes and Interphasial Chemistry

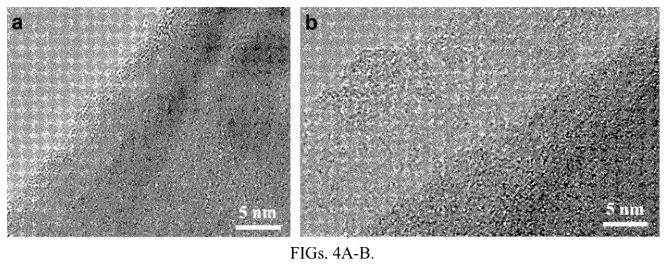

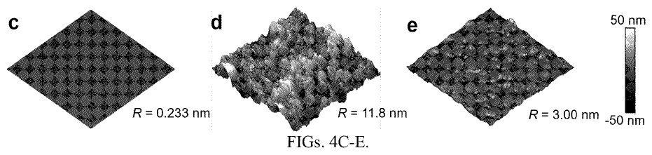

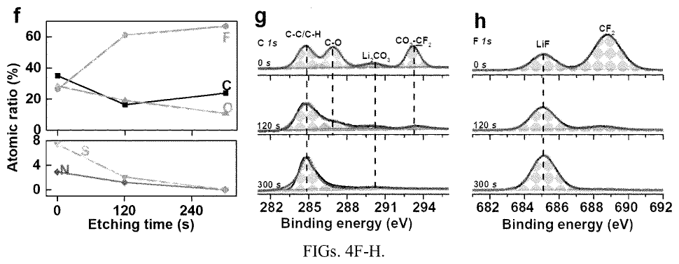

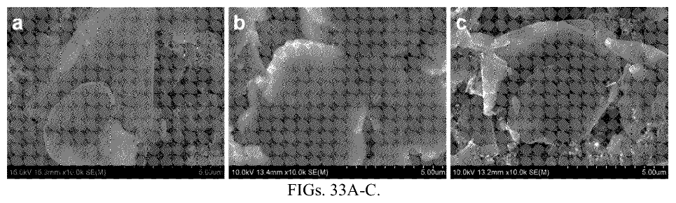

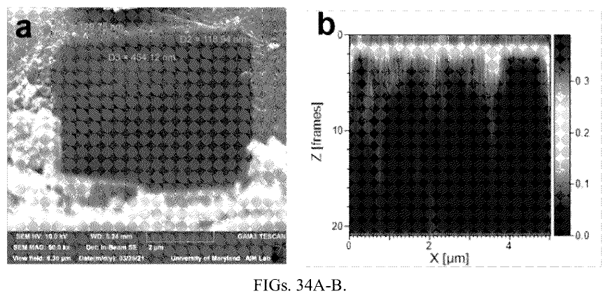

To identify the interphasial chemistry, the morphology and composition of the SEI on graphite anodes were systematically investigated. Under high-resolution transmission electron microscopy (HRTEM), a uniform and thin SEI of around 2 nm was observed on the graphite anode after 20 cycles in MDFA/MDFSA-based electrolyte (FIG. 4A). Such low thickness approaches the theoretical lower limit of an interphase, which reflects the effectiveness of the LiF-based interphases in insulating electron tunneling. In contrast, a much thicker SEI layer of ˜14 nm was observed for EC/DEC-based electrolytes (FIG. 4B). The roughness and thickness of the SEI were also studied by electrochemical atomic force microscopy (AFM). As shown in FIGS. 4C-E, the pristine graphite particles have a smooth surface with ˜0.233 nm roughness. In good agreement with the HRTEM observations, the roughness of the cycled graphite in the MDFA/MDFSA-based electrolyte obtained by AFM increased to ˜3.0 nm (FIG. 4E), much smaller than the value of ˜11.8 nm in the EC/DEC-based electrolyte (FIG. 4D). X-ray diffraction (XRD) and SEM were also employed to characterize the graphite anodes after 20 cycles at −30° C. According to the XRD patterns (FIG. 32), the graphite cycled in both MDFA/MDFSA electrolyte and EC/DEC-electrolyte show negligible change from the pristine one, verifying the structural integrity after cycling. SEM reveals that the surfaces of graphite with EC/DEC-based electrolytes are covered with a thick SEI while much thinner SEI was observed in MDFA/MDFSA-based electrolytes (FIG. 33).

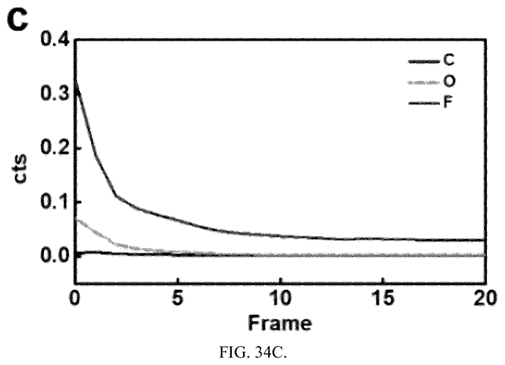

To identify the chemical composition of the SEI on cycled graphite anodes, X-ray photoelectron spectroscopy (XPS) with an Ar⁺ sputtering depth profiling was performed. The elements and their related atomic ratios detected in the SEI on graphite recovered from 1M LiTFSI MDFA/MDFSA-TTE electrolyte are summarized in FIG. 4F, and the C 1s and F 1s spectra are shown in FIG. 4G and FIG. 4H, respectively. The top surface of the SEI is composed of both organic (CO₂CF₂) and inorganic (LiF, Li₂CO₃) components. N and S are found in the SEI from MDFA/MDFSA-based electrolytes, which arise from the decomposition of the TFSI⁻ anion and MDFA co-solvent. In the C 1s spectra (FIG. 4G), the organic signals (C—O, CO₂CF₂) drop to the noise level at 300 s of sputtering, while the LiF signal persists throughout the whole sputtering process (FIG. 4H). Combining the results from the C 1s and F 1s spectra, it is concluded that a robust bilayer SEI with LiF-rich inner layer and organic-rich outer layer was formed. The time-of-flight secondary ion mass spectrometry (TOF-SIMS) spectrum collected in negative polarity in the 5-60 m/z range verified the formation of LiF-rich SEI (FIG. 34).

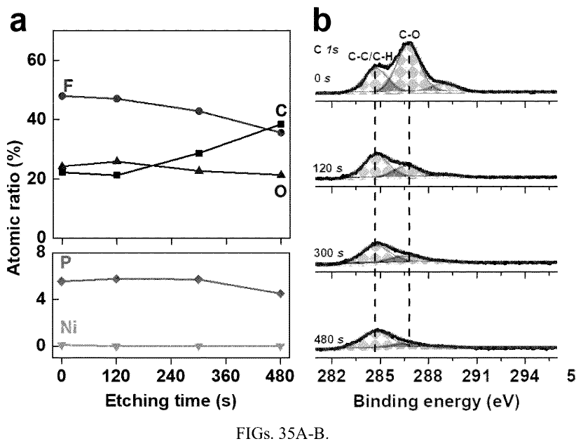

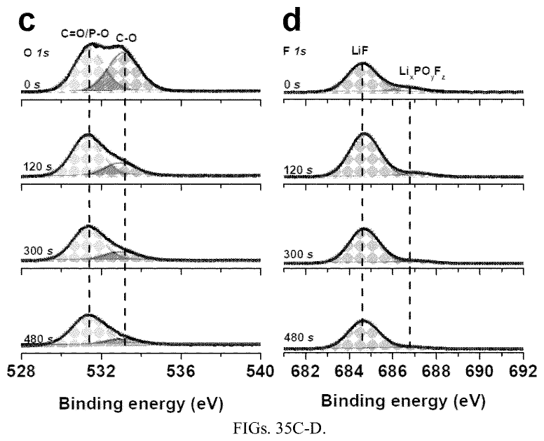

The XPS spectra from EC/DEC-based electrolytes (FIG. 35) show that the SEI components on graphite largely differ from those in the MDFA/MDFSA-based electrolytes. P signal was detected in the SEI derived from LiPF₆ salt even after 480 s etching, indicating the SEI is much thicker than that generated in MDFA/MDFSA-based electrolyte. In the EC/DEC-based electrolytes the signal intensity is lower for LiF, but higher for C═O/P—O, C—O contained species, suggesting the SEI consists of more organic compounds than LiF. The Ni 2p signal can be seen on the cycled graphite in EC/DEC-based electrolyte, apparently due to the dissolution of active species from NMC811 cathodes, while the Ni 2p signal was absent on the SEI on cycled graphite in MDFA/MDFSA-based electrolyte, demonstrating the MDFA/MDFSA-based electrolyte generated a better CEI to suppress such parasitic dissolution even at such high cut-off voltage of 4.5 V.

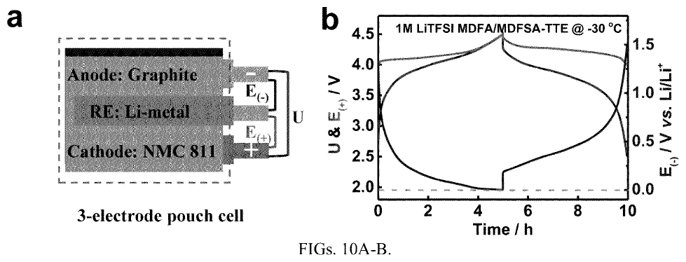

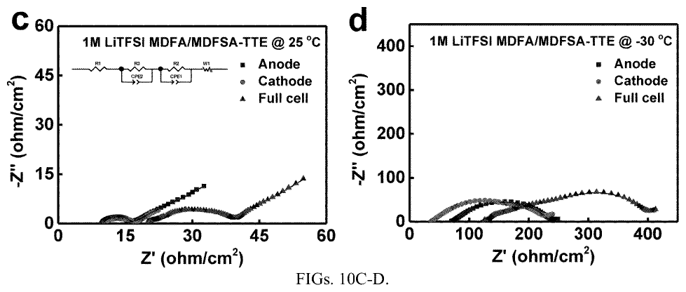

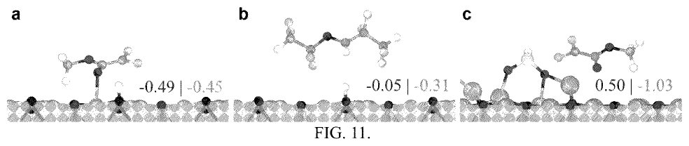

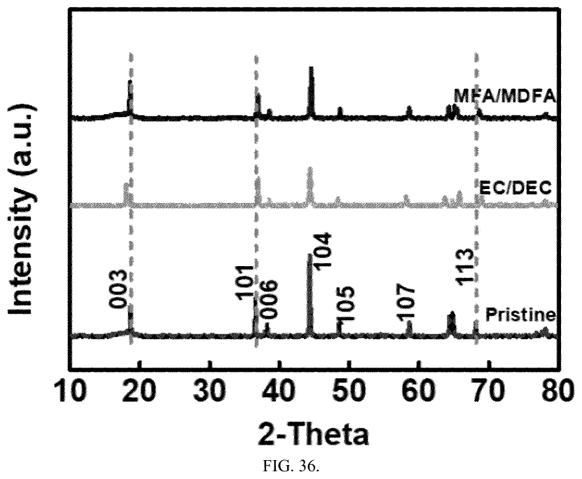

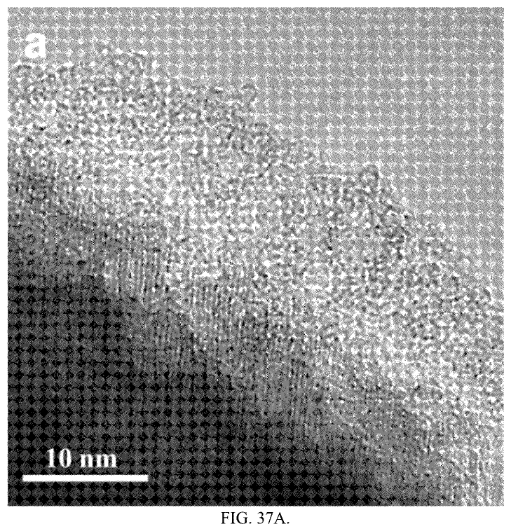

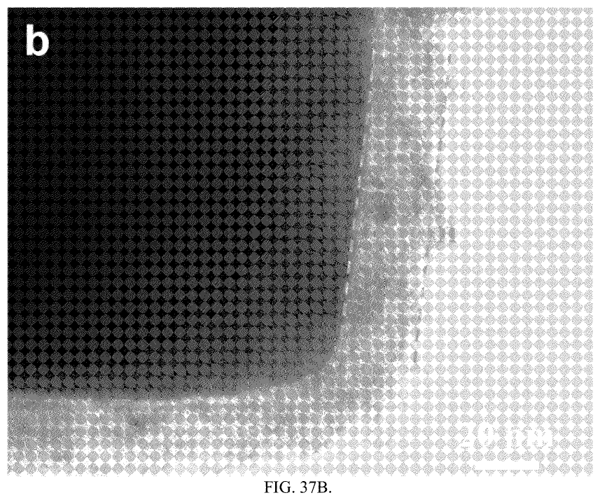

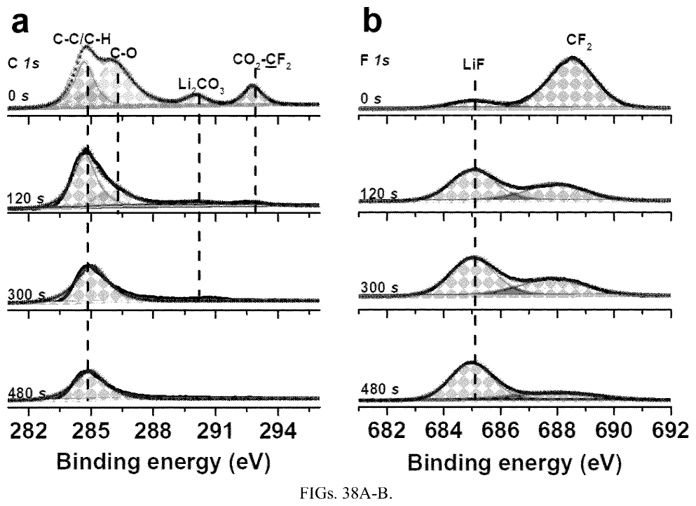

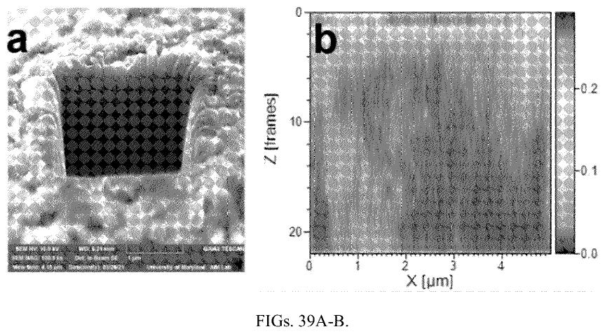

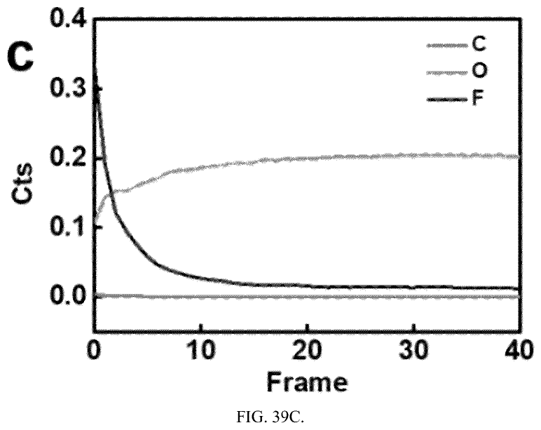

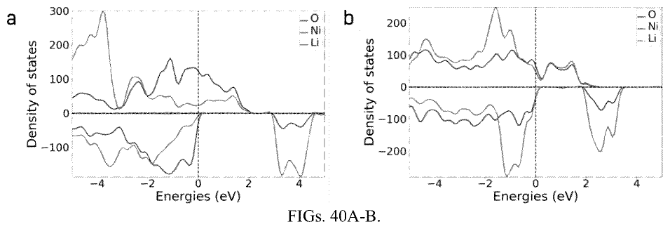

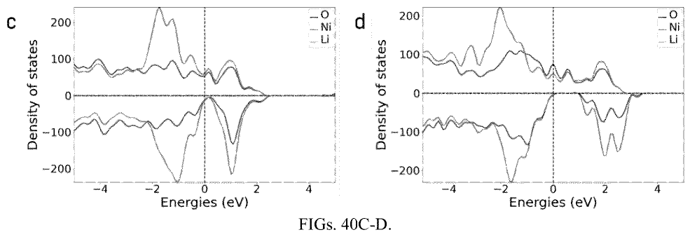

Characterization of NMC811 cathode interphases also revealed the formation of LiF-rich inner layer and organic-rich outer layer CEI in MDFA/MDFSA-based electrolyte. The (003) reflection at 2-theta of 19.0 for the NMC811 recovered from EC/DEC electrolytes slightly shifted to a lower scattering angle (FIG. 36, as marked by dotted lines), reflecting a decline in the degree of lithiation. This is because the organic-rich CEI formed in EC/DEC electrolytes cannot effectively protect NMC811, resulting in the dissolution of Ni, Mn, and Co from NMC811 and inducing phase changes on the NMC811 surface. The LiF-rich CEI formed in MDFA/MDFSA-based electrolyte constructs a dense, compact and thinner (˜9 nm) barrier than that of ˜24 nm formed in EC/DEC-based electrolyte (FIG. 37). This CEI effectively passivate the NMC811, stabilizing its structure. The formation of bilayer CEI with LiF-rich inner layer and organic-rich outer layer is supported by the XPS characterization in FIG. 38 and TOF-SIMS results presented in FIG. 39. DFT calculations of reaction energies of MDFA, TTE, and MDFSA on a 4-layer slab model of LiₓNiO₂ (104) corroborate these observations. At high potentials, surface oxygens become highly reactive, and electrolyte species in contact with these surfaces are subject to dehydrogenation, which sets the upper limit on the anodic stability window. For the half-lithiated surface, it was found that dehydrogenation of MDFA without chemisorption of the radical on the CF₂ carbon, is energetically favorable with a reaction energy of −0.49 eV with PBE+U and a similar energy of −0.45 eV using the SCAN functional (FIG. 11A). Dehydrogenation of TTE on Li_{0.5}NiO₂ may also be possible, proceeding with a much smaller reaction energy of −0.05 eV with PBE+U. The reaction is somewhat more favorable when considering the SCAN functional, giving an energy of −0.31 eV (FIG. 11B). Lastly, cluster calculations discussed previously predict Li⁺-MDFA reduction potentials in the range of 3.6 to 4.0 V, corresponding to the loss of SO₂F products on the higher end of that range and direct defluorination on the lower end. The high reduction potentials computed for these reactions are not only relevant for SEI formation but could also factor into CEI formation at low state of charge or at open circuit voltage when the cathode is in the discharged state. On Li_{1.0}NiO₂, PBE+U predicts a reaction energy of 0.50 eV for Li⁺-MDFSA to form the SO₂F product with a sizeable shift to −1.03 eV observed for the same configuration using SCAN (FIG. 11C). The differences in reaction energy between PBE+U and SCAN methods can be attributed to the low density of states for Ni 3d electrons near the Fermi energy that are a consequence of the Hubbard correction needed to localize electron density on transition metals. This difference is best illustrated in the partial density of states for Li_{0.5}NiO₂ and Li_{1.0}NiO₂ bare surfaces as shown in FIG. 40. The Hubbard corrected PBE functional for Li_{1.0}NiO₂ underestimates Ni 3d-O 2p hybridization which tends to make Ni more difficult to oxidize resulting in a positive reaction energy; these differences are diminished for Li_{0.5}NiO₂. The O 2p density of states near the Fermi energy are similar across functionals since no Hubbard term is used for O 2p in either case. In the Li_{1.0}NiO₂ structure, the SCAN functional better reproduces the hybridization behavior and increases the density of states of Ni 3d electrons near the Fermi energy. Downstream decomposition of the SO₂F product is the most likely source of the thin LiF-rich layer in the inner part of the CEI with byproducts of MDFA and TTE dehydrogenation and radical condensation comprising the fluorine-rich organic outer layer.

### Example 5. Materials and Methods

Methyl difluoroacetate (MDFA), Methyl 2,2-difluoro-2 (fluorosulfonyl)acetate (MDFSA), Methyl 2,3,3,3-tetrafluoro propionate (M4FP), Ethyl difluoroacetate (EDFA), 1,1,2,2-Tetrafluoroethyl-2,2,3,3-tetrafluoropropylether (TTE) were purchased from SynQuest Labs, Inc. and used after being dehydrated by molecular sieve 4 Å. Lithium bis(trifluoromethanesulfonyl)imide (LiTFSI), purchased from Gotion Inc, was dissolved into mixed solvents (MDFA:MDFSA:TTE=4:1:5, volume ratio) in predetermined concentrations in a glovebox filled with argon. The water content of the solution, as measured by a Karl Fischer aquameter, was 5 ppm or less. The solution of 1M LiPF₆ in EC/DEC=50/50 (v/v), battery grade (Sigma Inc.) was used as received as a comparison. Ionic conductivities of the electrolytes were calculated from the high frequency intercept of EIS impedance spectra measured in symmetric Pt|Pt Swagelok blocking cells at various temperatures (−60° C. to +60° C.). Each sample subjected to differential scanning calorimeter (DSC) measurement was packed in a stainless steel pan, which was then crimp-sealed in a glove box filled with argon. All of the DSC experiments were carried out at a cooling/heating rate of 5° C./min.

Cathode coating of NMC811 (LiNi_{0.8}Mn_{0.1}Co_{0.1}O₂) on Al foil was kindly provided by Saft America Inc. These electrodes are composed of 94 wt % NMC811, 3 wt % carbon and 3 wt % PVDF, with ˜30% porosity and 2.5 mAh cm⁻² areal capacity (mass loading ˜11.5 mg/cm²). Graphite powders within a narrow size distribution (3.5±1.5 μm) were obtained from China Steel Chemical Corp. Graphite electrodes were prepared by mixing graphite with carbon black and PVDF in a weight ratio of 92:2:6 using N-methyl pyrrolidinone as the solvent and were cast onto a copper (Cu) foil, dried at 80° C. overnight under vacuum. The area capacity of graphite electrodes is 2.7 mAh cm⁻², corresponding to a N/P ratio of 1.08. These electrodes were cut into 1.2 cm² sheets, vacuum-dried at 80° C. for 24 h before assembling.

### Example 6. Electrochemical Measurements

CR2032 coin type full cells were assembled by sandwiching Celgard 2325 as a separator between the graphite anodes and NMC811 cathodes. For consistency, a fixed amount (40 μL) of liquid electrolyte was filled in all cells, and the Li-ion cells were formed at 0.2 C between 2.5 V and 4.5 V for two cycles prior to testing. The cycling performance and rate capability of NMC811∥graphite full cells with an areal capacity of 2.5 mAh cm⁻² and N/P ratio of 1.1 in different electrolytes were examined in the voltage range of 2.5-4.5 V. Cycling conditions for each test are described in the discussion section or figure captions. C-rate was determined by the charging time, for example, 1 C equal to 1 h. As for the pouch cells, aluminum and nickel strips were attached as electrode tabs to the sides of the cathode and anode, respectively. All the electrodes, separators, and liquid electrolytes were the same as those used in coin cells. All single-layer pouch cells (5 cm×7 cm) were vacuum sealed in a dry room in Saft Corporation without electrolyte and then shipped to the University of Maryland for electrolyte infiltration. Varied amounts of electrolytes (3.5, 3.0, 2.5 g/Ah) were injected into the package for comparison. As with the coin cells, the pouch full cells with the same N/P ratio of 1.1 and areal capacity of 2.5 mAh cm⁻² were charged/discharged at the same temperatures in all tests. Impedance spectra of three-electrode cells were tested over the frequency range of 0.01-1,000,000 Hz using pouch cells that incorporate a small piece of lithium metal as the reference electrode.

### Example 7. Molecular Dynamics Simulations

MD simulation cell of LiTFSI in MDFA/MDFSA-TTE contained 330 MDFA, 75 MDFSA, 380 TTE and 96 LiTFSI, while LiTFSI in MDFA cells contained 1100 MDFA and 96 LiTFSI. A polarizable force field APPLE&P with the previously developed LiTFSI, TTE parameters was used. The Li⁺(MDFA) and Li⁺(MDFSA) interactions, solvent charges and polarizabilities were fit using methodology from previous work but utilizing MP2/aug-cc-pvTz to compute electrostatic potential on a grid around solvents to fit charges, PBE/6-31+G(d,p) to compute the Li⁺ binding energy and polarizability on a grid around solvents and G4MP2 to calculate Li⁺ binding energy to solvents for the most favorable geometries.

The length of equilibration and production runs, simulation temperatures, density, and the number of independent simulated replicas are summarized in Table 4. The equations of motions were solved with a time reversible (RESPA) integrator over the following time resolutions: i) the contribution from bonds and angles to the forces were calculated at any 0.5 femtosecond (fs), ii) the contribution of dihedrals and non-bonded forces within 8 Å cut-off were updated at any 1.5 fs, and iii) the remainder of the forces (reciprocal space Ewald using k=8³ vectors and non-bonded forces within 12 or 14 Å cut-off were updated at any 3 fs. Nose-Hoover thermostat was used for temperature control with the associated frequency of 0.01 fs⁻¹.

TABLE 4
Summary of MD simulation equilibration and production runs.
LiTFSI in MDFA-MDFSA-TTE

| | | | | | |
|---|---|---|---|---|---|
| Number of replicas | 4 | 2 | 2 | 1 | 1 |
| T (° C.) | 60 | 25 | 0 | −30 | −60 |
| Equilibration runs (ns) | 108 | 37 | 81.7 | 161.9 | 118 |
| Production runs (ns) | 651 | 200 | 398 | 335 | 224.1 |
| Density (kg m⁻³) | 1433 | 1491 | 1554 | 1578 | 1628 |

LiTFSI in MDFA

| | | |
|---|---|---|
| Number of replicas | 2 | 2 |
| T (° C.) | 60 | 25 |
| Equilibration runs (ns) | 27.5 | 50.1 |
| Production runs (ns) | 301.0 | 450.2 |
| Density (kg m⁻³) | 1280 | 1335 |

### Example 8. Quantum Chemistry Calculations of Li⁺ Solvation

The Li⁺(solvent) binding energies (shown in FIG. 1C) were calculated using DFT with PBE functional, 6-31+G(d,p) basis set with solvent and Li⁺(solvate) immersed in implicit solvent that is modeled using PCM(ether) as implemented in Gaussian software package.

The reduction potential for the complexes of interest, denoted as complex A, was calculated as the negative of the free energy of formation of A⁻ in solution [ΔG^{S}₂₉₈−G^{S}₂₉₈(A⁻)−G^{S}₂₉₈(A)] divided by Faraday's constant as given by:

$${G}^{red} = - ( Δ {G}_{298 K}^{S} ) / F - 1.4 V$$

The difference between the Li⁺/Li and absolute reduction potential of 1.4 V was subtracted to convert results to Li⁺/Li scale as discussed extensively elsewhere.

### Example 9. Modeling of Surface Reactions

Calculations for the determination of reaction energies for decomposition reactions on a 4-layer slab model of LiNiO₂ (1 0 4) were performed using VASP 5.4. All structure optimizations were performed using PBE+U (U=5.96 eV, for Ni) and _sv and _pv potentials for Li and Ni, respectively. Only the gamma point is considered for surface calculations. Single point energies were also computed with the SCAN functional. The plane wave basis was expanded to 520 eV for PBE methods and 800 eV for SCAN. Dipole corrections were used in optimizations and single point energy calculations as well. In calculations with Li⁺-MDFA, a single F ion was added elsewhere on the surface to neutralize the cell. The reactant state used here is the minimum energy physisorbed state. Calculations were prepared using Atomic Simulation Environment and density of states were analyzed with the VASP plugin in pymatgen. Visuals produced with VESTA.

### Example 10. Screening Solvent Reduction Stability Using Density Functional Theory

The reduction stability of electrolyte solvent was calculated using density functional theory (DFT) and three types of models. The three models in the order of increasing complexity and computational cost are: a) isolated solvents, b) Li⁺(solvent) and c) Li⁺(MDFA)₃(solvent) clusters. All solvents/solvates were immersed in implicit solvent using diethyl ether parameters. A polarizable continuum model with solvent excluding surface PCM(SES) was used in the high throughput screening. We screened all conformers for the isolated solvent and Li⁺(solvent) complexes with Li⁺ binding to all oxygen, nitrogen and fluorine atoms of solvents (>10,000 calculations) and reported results for the most energetically stable configurations in Table 5. Up to five of the most stable configurations of the Li⁺(solvent) complexes were used to generate initial configurations for the Li⁺(MDFA)₃(solvent) solvates by replacing one MDFA in Li⁺(MDFA)₄ with a test solvent as shown in Table 6.

Screening was initiated by analyzing vertical reduction energy (Event), which is the fastest calculation because it does not require geometry optimization of the reduced complex. On the other hand, it also does not account for molecular deformation including bond breaking that could occur as a result of reduction. Vertical reduction energy shows that MDFSA has the highest reduction potential, followed by fluorinated esters (M3FA, MDFA, EDFA), while ethers such as DME, THF have the lowest reductions potential. Examination of adiabatic reduction energies (E_{red}) and free energies (G_{red}) for isolated solvents indicates that fluorinated esters not only have reduction free energies above 0 V vs. Li/Li⁺ but also undergo energetically favorable C—F bond breaking after reduction resulting in a higher reduction potential. TTE and MDFSA also exhibit the C—O and C—S bond breaking, respectively, in addition to the C—F bond breaking during geometry optimization of the reduced complex indicating that these molecules are good sources of F⁻ and highly fluorinated fragments for SEI formation.

Li⁺ binding to the reduced solvents leads to solvent polarization due to strong interaction with the excess electron in the reduced solvent resulting in higher reduction potentials by 0.5-1.9 V. Reduction free energies are in good agreement with available experimental values. Reduction free energies of Li⁺DMFSA span a broad range from 4 V due to C—S bond breaking and LiSO₂F formation to LiF formation at 2.3-3 V range. Semi-fluorinated esters exhibit the next highest reduction potential in the range of 1-1.73 V without bond breaking to 2.0-2.6 V when the C—F bond breaks during reduction and LiF forms. The latter process requires larger reorganization energy and is kinetically expected to be much slower than reduction without bond breaking (from Marcus theory).

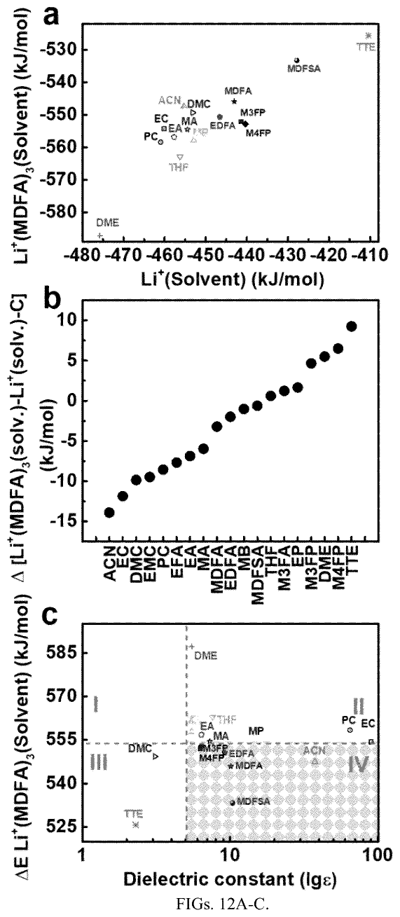

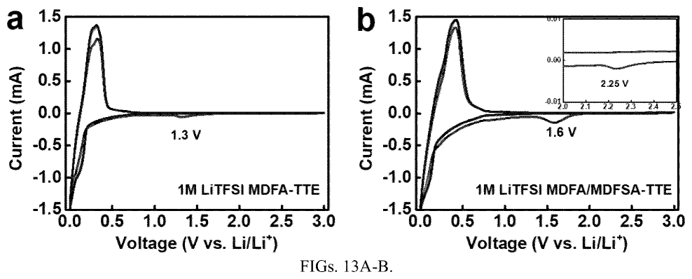

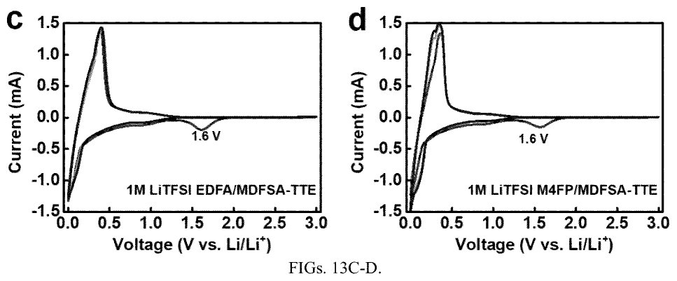

Using MFDA as a main solvent, we examined reduction of the Li⁺(MDFA)₃(solvent) clusters for a small subset of solvents listed in Table 6. For all solvates but Li⁺(MDFA)₃ (MDFSA) and Li⁺(MDFA)₃ (M4FP), the MDFA solvent underwent reduction while the other solvent (EC, ACN, DMC, DMC, MA, EA, MB, M3FP, EFA TTE, EDFA, EFA, DOL, EP, EMC) remained neutral. Reduction potentials for these complexes and Li⁺(DMFA)₄ were in the range of 1.17-1.51 V, which is consistent with the reduction peak at 1.3 V observed in CV in FIG. 13. If C—F bond breaking is coupled with reduction, the reduction potential for these solvates was slightly higher 1.65-2.05 V but it required a solvating site for F to be readily available nearby and is expected to be kinetically slower due to larger reorganization energy. Calculations show that the sp² carbon in a fluorinated ester such as MDFA (with fluorine atoms and oxygen pulling electron density away from this sp² C(═O)) could serve as a transient solvation site for F after C(sp³)-F bond breaking coupled with reduction. This behavior is consistent with lower Li⁺(solvent) reduction potentials [without bond breaking] for these solvents compared to Li⁺MDFA shown in Table 5. For the Li⁺(MDFA)₃ (M4FP) solvates reduction of both MDFA and M4FP were observed with similar reduction potentials, which is consistent with similar reduction potentials for Li⁺(MDFA) and Li⁺ (M4FP) shown in Table 5. Reduction of Li⁺(MDFA) (MDFSA) yielded a potential of 1.76-2.05 for MDFA reduction with C—F bond breaking, and MDFSA reduction with C—S bond breaking occurring at 3.70-3.93 V. High reduction potential within cathode cycling makes MDFSA a good candidate for additive/co-solvent to form CEI on cathode surface. Similar conclusions were reached by considering the MDFA and MDFSA solvates when C—F and S—C bonds were broken manually.

TABLE 5
Adiabatic reduction energies (E_{red}), free energies (G_{red}) and vertical reduction reduction
energies (Eᵥₑᵣₜ) in Volts vs. Li/Li⁺ from wB97XD/6-31 + G(d, p) DFT calculations for
the isolated solvents and Li⁺(solvent) complexes immersed in ether implicit solvent.

| Solvent name (cid) | E_{red} | G_{red} | Eᵥₑᵣₜ | | E_{red} | G_{red} | Eᵥₑᵣₜ |
|---|---|---|---|---|---|---|---|
| ACN(6342) | −0.75 | −0.62 | −1.55 | Li⁺ACN(6342) | −0.17 | −0.12 | −0.17 |
| DME(8071) | −1.84 | −1.78 | −2.29 | Li⁺DME(8071) | −0.17 | −0.11 | −0.34 |
| THF(8028) | −1.87 | −1.81 | −1.89 | Li⁺THF(8028) | −0.07 | −0.01 | −0.07 |
| DOL(12586) | −1.83 | −1.77 | −1.85 | Li⁺DOL(12586) | −0.01 | 0.04 | −0.02 |
| TTE(2776662) | 1.06^{a} | −1.36, 1.39^{a} | −2.02 | Li⁺TTE(2776662) | 0.11 | 0.01 | −0.37 |
| DEC(7766) | −0.93 | −0.79 | −1.99 | Li⁺DEC(7766) | 0.43 | 0.52 | −0.13 |
| EMC(522046) | −0.90 | −0.74 | −1.94 | Li⁺EMC(522046) | 0.52 | 0.63 | −0.12 |
| DMC(12021) | −0.87 | −0.72 | −1.88 | Li⁺DMC(12021) | 0.55 | 0.68 | −0.13 |
| EA(8857) | −0.85 | −0.74 | −1.82 | Li⁺EA(8857) | 0.56 | 0.64 | −0.11 |
| PC(7924) | −0.66 | −0.53 | −1.60 | Li⁺PC(7924) | 0.57 | 0.67 | −0.18 |
| EP(7749) | −0.96 | −0.78 | −1.79 | Li⁺EP(7749) | 0.58 | 0.64 | −0.08 |
| EC(7303) | −0.63 | −0.49 | −1.73 | Li⁺EC(7303) | 0.59 | 0.68 | −0.17 |
| MA(6584) | −0.84 | −0.70 | −1.83 | Li⁺MA(6584) | 0.62 | 0.68 | −0.1 |
| MP(11124) | −0.86 | −0.75 | −1.80 | Li⁺MP(11124) | 0.62 | 0.69 | −0.1 |
| MB(12180) | −0.86 | −0.77 | −1.91 | Li⁺MB(12180) | 0.62 | 0.72 | −0.09 |
| M3FP(2782392) | −0.45 | −0.31 | −1.82 | Li⁺M3FP(2782392) | 0.98 | 1.05 | −0.04 |
| M3FA(9893) | 0.23 | 0.34 | −0.78 | Li⁺M3FA(9893) | 1.55 | 1.73 | 0.49 |
| EDFA(9961) | 0.59^{a} | 0.05, 0.80^{a} | −1.02 | Li⁺EDFA(9961) | 1.92^{a} | 1.37, 2.02^{a} | 0.31 |
| MDFA(79012) | 0.63^{a} | 0.20, 0.84^{a} | −0.97 | Li⁺MDFA(79012) | 1.97^{a} | 1.40, 2.07^{a} | 0.36 |
| MFA(9959) | 0.51^{a} | 0.72^{a} | −1.77 | Li⁺MFA(9959) | 2.13^{a} | 1.00, 2.26^{a} | −0.1 |
| EFA(9988) | 0.52^{a} | −1.65, 0.78^{a} | −1.79 | Li⁺EFA(9988) | 2.28^{a} | 0.97, 2.43^{a} | −0.13 |
| M4FP(67840) | 0.78^{a} | 0.96^{a} | −1.09 | Li⁺M4FP(67840) | 2.43^{a} | 1.42, 2.56^{a} | 0.21 |
| MDFSA(547667) | 2.46^{a} | 0.85, 2.81^{a} | 0.10 | Li⁺MDFSA(547667) | 3.85^{a} | 4.02^{a} | 1.19 |

^{a}bond breaking occurred during reduction resulting in multiple reduction products.

^{a} bond breaking occurred during reduction resulting in multiple reduction products. Only the most stable one is listed.

Table 6. Adiabatic reduction free energies in volts vs. Li/Li⁺ from wB97XD/6-31+G(d,p) DFT calculations for Li⁺(MDFA)₃(solvent) solvates immersed in ether implicit solvent categorized by MDFA or solvent reduction within the solvate and whether bond braking occurred as a result of reduction.

| | reduced species in the solvate | | |
|---|---|---|---|
| | MDFA (no | MDFA (C—F | Solvent |
| Li⁺(MDFA)₃(solvent) | bond | bond | with bond |
| solvate | breaking) | breaking) | breaking |
| Li⁺(MDFA)₃EC | 1.19 | 1.58 | |
| Li⁺(MDFA)₃ACN | | 1.74 | |
| Li⁺(MDFA)₃DME | 1.17 | 1.66 | |
| Li⁺(MDFA)₃DMC | 1.34 | 1.73 | |
| Li⁺(MDFA)₃MA | 1.32 | 1.94 | |
| Li⁺(MDFA)₃EA | 1.37 | 1.81 | |
| Li⁺(MDFA)₃MB | 1.21 | 1.80 | |
| Li⁺(MDFA)₃M3FP | 1.34 | 1.83 | |
| Li⁺(MDFA)₃MDFA | 1.36 | 1.87 | |
| Li⁺(MDFA)₃EFA | 1.35 | 1.81 | |
| Li⁺(MDFA)₃M4FP | 1.39 | 1.91 | 1.91 |
| Li⁺(MDFA)₃MDFSA | | 1.75-2.05 | 3.93 |
| Li⁺(MDFA)₃TTE | 1.41 | 1.81 | |
| Li⁺(MDFA)₃EDFA | 1.33 | 1.85 | |
| Li⁺(MDFA)₃M3FA | 1.50 | 1.66 | |
| Li⁺(MDFA)₃EFA | 1.35 | 1.81 | |
| Li⁺(MDFA)₃DOL | 1.38 | 1.84 | |
| Li⁺(MDFA)₃EP | 1.28 | 1.65 | |
| Li⁺(MDFA)₃EMC | 1.18 | 1.84 | |

TABLE 7
Physical properties of commonly used organic solvents.

| | Di- | | Freez- | Boil- | | |
|---|---|---|---|---|---|---|
| | electric | Donor | ing | ing | Flash | Den- |
| | constant | number | point | Point | point | sity |
| Solvent | (ε) | (DN) | (° C.) | (° C.) | (° C.) | (kg/m³) |
| Ethylene | 90.1 | / | 34-37 | 243 | 150 | 1.32 |
| Carbonate (EC) | | | | | | |
| Fluoroethylene | 78.4 | / | 19-20 | 210 | 102 | 1.45 |
| carbonate (FEC) | | | | | | |
| Propylene | 64.9 | / | −48 | 242 | 132 | 1.20 |
| Carbonate (PC) | | | | | | |
| dimethyl sulfoxide | 46.7 | 29.8 | 19 | 189 | 89 | 1.10 |
| (DMSO) | | | | | | |
| Tetrahydrofuran | 7.6 | 20.0 | −108.5 | 66 | 17 | 0.89 |
| (THF) | | | | | | |
| 1,2- | 5.5 | 20 | −58 | 85 | −2 | 0.87 |
| dimethoxyethane | | | | | | |
| (DME) | | | | | | |
| Dimethyl | 3.1 | 17.2 | 3 | 90 | 17 | 1.06 |
| Carbonate (DMC) | | | | | | |
| Diethyl Carbonate | 2.8 | 16.0 | −43 | 127 | 25 | 0.97 |
| (DEC) | | | | | | |
| Acetonitrile | 37.5 | 14.1 | −44 | 81.6 | 5.6 | 0.78 |
| (CH₃CN) | | | | | | |
| Diethyl ether | 4.3 | 19.2 | −117 | 35 | −45 | 0.71 |
| (DEE) | | | | | | |
| Ethyl acetate (EA) | 6.0 | 17.1 | −84 | 77 | −4 | 0.90 |
| Methyl propionate | 6.2 | 11.0 | −88 | 79 | −2 | 0.92 |
| (MP) | | | | | | |
| Methyl acetate | 7.3 | 16.5 | −98 | 57 | 22 | 0.93 |
| (MA) | | | | | | |
| 1,4-Dioxane | 2.3 | 14.8 | 12 | 101 | 12 | 1.03 |
| Methyl | 10.1 | 8.4 | <−90 | 86 | 75 | 1.26 |
| difluoroacetate | | | | | | |
| (MDFA) | | | | | | |

All publications mentioned herein are incorporated by reference to the extent they support the present invention.

### REFERENCES

A number of patents and publications are cited above in order to more fully describe and disclose the invention and the state of the art to which the invention pertains. Full citations for these references are provided below.
[1] Goodenough, J. B. & Kim, Y. Challenges for rechargeable Li batteries. Chem. Mater. 22, 587-603 (2010).
[2] Winter, M., Barnett, B. & Xu, K. Before Li ion batteries. Chem. Rev. 118, 11433-11456 (2018).
[3] Liu, Y., Zhu, Y. & Cui, Y. Challenges and opportunities towards fast-charging battery materials. Nat. Energy 4, 540-550 (2019).
[4] Rodrigues, M.-T. F. et al. A materials perspective on Li-ion batteries at extreme temperatures. Nat. Energy 2, 1-14 (2017).
[5] Xu, K. Nonaqueous liquid electrolytes for lithium-based rechargeable batteries. Chem. Rev. 104, 4303-4418 (2004).
[6] Smart, M. et al. Improved low-temperature performance of lithium-ion cells with quaternary carbonate-based electrolytes. J. Power Sources 119, 349-358 (2003).
[7] Herreyre, S. et al. New Li-ion electrolytes for low temperature applications. J. Power Sources 97, 576-580 (2001).
[8] Dong, X., Guo, Z., Guo, Z., Wang, Y. & Xia, Y. Organic batteries operated at −70° C. Joule 2, 902-913 (2018).
[9] Rustomji, C. S. et al. Liquefied gas electrolytes for electrochemical energy storage devices. Science 356 (2017).
Holoubek, J. et al. Tailoring electrolyte solvation for Li metal batteries cycled at ultra-low temperature. Nat. Energy 6, 303-313 (2021).
Zhang, S., Xu, K. & Jow, T. A new approach toward improved low temperature performance of Li-ion battery. Electrochem. Commun. 4, 928-932 (2002).
Huang, C. K., Sakamoto, J., Wolfenstine, J. & Surampudi, S. The limits of low-temperature performance of Li-ion cells. J. Electrochem. Soc. 147, 2893 (2000).
Zhang, S., Xu, K. & Jow, T. Low temperature performance of graphite electrode in Li-ion cells. Electrochim. Acta 48, 241-246 (2002).
Petzl, M., Kasper, M. & Danzer, M. A. Lithium plating in a commercial lithium-ion battery-A low-temperature aging study. J. Power Sources 275, 799-807 (2015).
Cai, W. et al. The Boundary of Lithium Plating in Graphite Electrode for Safe Lithium-Ion Batteries. Angew. Chem., Int. Ed. 133, 13117-13122 (2021).
Johnson, L. et al. The role of LiO₂ solubility in O₂ reduction in aprotic solvents and its consequences for Li—O₂ batteries. Nat. Chem. 6, 1091-1099 (2014).
Burke, C. M., Pande, V., Khetan, A., Viswanathan, V. & McCloskey, B. D. Enhancing electrochemical intermediate solvation through electrolyte anion selection to increase nonaqueous Li—O₂ battery capacity. Proc. Natl. Acad. Sci. 112, 9293-9298 (2015).
Holoubek, J. et al. An all-fluorinated ester electrolyte for stable high-voltage Li metal batteries capable of ultra-low-temperature operation. ACS Energy Lett. 5, 1438-1447 (2020).
Ihara, M. et al. Properties of carbon anodes and thermal stability in LiPF₆/methyl difluoroacetate electrolyte. J. Electrochem. Soc. 150, A1476 (2003).
Cho, Y.-G. et al. Enabling the Low-Temperature Cycling of NMC∥Graphite Pouch Cells with an Ester-Based Electrolyte. ACS Energy Lett. 6, 2016-2023 (2021).
Henderson, W. A. Glyme-lithium salt phase behavior. J. Phys. Chem. B 110, 13177-13183 (2006).
Chu, H. et al. Achieving three-dimensional lithium sulfide growth in lithium-sulfur batteries using high-donor-number anions. Nat. Commun. 10, 1-12 (2019).
Linert, W., Camard, A., Armand, M. & Michot, C. Anions of low Lewis basicity for ionic solid state electrolytes. Coord. Chem. Rev. 226, 137-141 (2002).
Li, Y., Lu, Y., Adelhelm, P., Titirici, M.-M. & Hu, Y.-S. Intercalation chemistry of graphite: alkali metal ions and beyond. Chem. Soc. Rev. 48, 4655-4687 (2019).
Xue, W. et al. FSI-inspired solvent and “full fluorosulfonyl” electrolyte for 4 V class lithium-metal batteries. Energy Environ. Sci. 13, 212-220 (2020).
Seo, D. M., Borodin, O., Han, S.-D., Boyle, P. D. & Henderson, W. A. Electrolyte solvation and ionic association II. Acetonitrile-lithium salt mixtures: highly dissociated salts. J. Electrochem. Soc. 159, A1489 (2012).
Chen, J. et al. Electrolyte design for LiF-rich solid-electrolyte interfaces to enable high-performance microsized alloy anodes for batteries. Nat. Energy 5, 386-397 (2020).
Bogle, X., Vazquez, R., Greenbaum, S., Cresce, A. v. W. & Xu, K. Understanding Li⁺-solvent interaction in nonaqueous carbonate electrolytes with ¹⁷O NMR. J. Phys. Chem. Lett. 4, 1664-1668 (2013).
Chen, S. et al. High-Voltage Lithium-Metal Batteries Enabled by Localized High-Concentration Electrolytes. Adv. Mater. 30, 1706102 (2018).
Ren, X. et al. Role of inner solvation sheath within salt-solvent complexes in tailoring electrode/electrolyte interphases for lithium metal batteries. Electrochem. Proc. Natl. Acad. Sci. 117, 28603-28613 (2020).
Zhang, X. et al. Advanced electrolytes for fast-charging high-voltage lithium-ion batteries in wide-temperature range. Adv. Energy Mater. 10, 2000368 (2020).
Yamaki, J.-I. et al. Thermal studies of fluorinated ester as a novel candidate for electrolyte solvent of lithium metal anode rechargeable cells. J. Power Sources 102, 288-293 (2001).
Beltrop, K. et al. Enabling bis(fluorosulfonyl)imide-based ionic liquid electrolytes for application in dual-ion batteries J. Power Sources 373, 193-202 (2018).
Waldmann, T. et al. Interplay of operational parameters on lithium deposition in lithium-ion cells: systematic measurements with reconstructed 3-electrode pouch full cells. J. Electrochem. Soc. 163, A1232 (2016).
Hammersley, A., Svensson, S., Hanfland, M., Fitch, A. & Hausermann, D. Two-dimensional detector software: from real detector to idealised image or two-theta scan. High Pressure Res. 14, 235-248 (1996).
Qiu, X., Thompson, J. W. & Billinge, S. J. PDFgetX2: a GUI-driven program to obtain the pair distribution function from X-ray powder diffraction data. J. Appl. Crystallogr. 37, 678-678 (2004).
Borodin, O. et al. Insights into the Structure and Transport of the Lithium, Sodium, Magnesium, and Zinc Bis(trifluoromethansulfonyl)imide Salts in Ionic Liquids. J. Phys. Chem. C 122, 20108-20121 (2018).
Glaser, R., Borodin, O., Johnson, B. R., Jhulki, S. & Yushin, G. Minimizing Long-Chain Polysulfide Formation in Li—S Batteries by Using Localized Low Concentration Highly Fluorinated Electrolytes. J. Electrochem. Soc 168, 090543 (2021).
Borodin, O. & Smith, G. D. Quantum Chemistry and Molecular Dynamics Simulation Study of Dimethyl Carbonate: Ethylene Carbonate Electrolytes Doped with LiPF₆. J. Phys. Chem. B 113, 1763-1776 (2009).
Gaussian 16 Rev. C.01 (Wallingford, CT, 2016).
Borodin, O. in Electrolytes for Lithium and Lithium-Ion Batteries Vol. 58 Modern Aspects of Electrochemistry (eds T. Richard Jow, Kang Xu, Oleg Borodin, & Makoto Ue) Ch. 8, 371-401 (Springer New York, 2014).
Jürgen, H. Ab-initio simulations of materials using VASP: Density-functional theory and beyond. J. Comput. Chem. 29, 2044-2078 (2008).
Dixit, M. et al. Thermodynamic and kinetic studies of LiNi_{0.5}Co_{0.2}Mn_{0.3}O₂ as a positive electrode material for Li-ion batteries using first principles. Phys. Chem. Chem. Phys. 18, 6799-6812 (2016).
Sun, J., Ruzsinszky, A. & Perdew, J. P. Strongly Constrained and Appropriately Normed Semilocal Density Functional. Phys Rev Lett 115, 036402 (2015).
Larsen, A. H. et al. The atomic simulation environment—a Python library for working with atoms. J. Phys.: Condens. Matter 29, 273002 (2017).
Ong, S. P. et al. Python Materials Genomics (pymatgen): A robust, open-source python library for materials analysis. Comput. Mater. Sci. 68, 314-319 (2013).
Momma, K. & Izumi, F. VESTA 3 for three-dimensional visualization of crystal, volumetric and morphology data. J. Appl. Crystallogr. 44, 1272-1276 (2011).
Delp, S. A. et al. Importance of Reduction and Oxidation Stability of High Voltage Electrolytes and Additives. Electrochimica Acta 209, 498-510, doi:http://dx.doi.org/10.1016/j.electacta.2016.05.100 (2016).
Yao, Y. X. et al. Regulating Interfacial Chemistry in Lithium-Ion Batteries by a Weakly Solvating Electrolyte. Angew. Chem., Int. Ed. 133, 4136-4143 (2021).
Kawamura, T. et al. Methyl Difluoroacetate Inhibits Corrosion of Aluminum Cathode Current Collector for Lithium Ion Cells. Electrochem. Solid-State Lett. 8, A459 (2005).
Smart, M. C., et al. Lithium-ion electrolytes containing ester cosolvents for improved low temperature performance. J. Electrochem. Soc. 157, A1361 (2010).
Lee, H., Wan, C. & Wang, Y. Thermal stability of the solid electrolyte interface on carbon electrodes of lithium batteries. J. Electrochem. Soc. 151, A542 (2004).
Campion, C. L., Li, W. & Lucht, B. L. Thermal decomposition of LiPF₆-based electrolytes for lithium-ion batteries. J. Electrochem. Soc. 152, A2327 (2005).
Li, T. et al. Degradation mechanisms and mitigation strategies of nickel-rich NMC-based lithium-ion batteries. Electrochem. Energy Rev. 3, 43-80 (2020).
Østergaard, T. M. et al. Oxidation of Ethylene Carbonate on Li Metal Oxide Surfaces. J. Phys. Chem. C 122, 10442 (2018).
Chakraborty, A., Dixit, M., Aurbach, D. & Major, D. T. Predicting accurate cathode properties of layered oxide materials using the SCAN meta-GGA density functional. npj Computational Materials 4, 60 (2018).

1. An electrolyte composition, said composition comprising a lithium salt dissolved in one or more solvents, wherein said solvent has a donor number <10, a dielectric constant >5, a boiling point greater than 60° C., and a melting point less than −60° C.

2. The electrolyte composition of claim 1, wherein the solvent is chosen from MDFA, MDFSA, M4FP, EDFA, TTE, and M3FP, or combinations thereof.

3. The electrolyte composition of claim 1, wherein the electrolyte comprises MDFA and MDFSA.

4. The electrolyte composition of claim 3, wherein the electrolyte composition comprises MDFA, MDFSA and TTE.

5. The electrolyte composition of claim 4, wherein the composition comprises said MDFA in the amount of about 20% to about 50%, said MDFSA in the amount of about 10% to about 25%, and said TTE in the amount of about 30% to about 60%.

6. The electrolyte composition of claim 1, wherein the lithium salt is chosen from LiTFSI, LiClO4, LiI, LiBF4, LiCF3SO3, LiNO3, LiBr, and LiCF3CO2, or combinations thereof.

7. The electrolyte composition of claim 1, wherein the lithium salt is LiTFSI.

8. The electrolyte composition of claim 1, wherein the lithium salt is present in at a concentration in the range of about 0.5 M to about 4 M.

9. A Li-ion battery, said battery comprising a cathode, an anode, and the electrolyte composition of claim 1.

10. The Li-ion battery of claim 9, wherein the cathode comprises NMC811, PVDF and carbon black.

11. The Li-ion battery of claim 9, wherein the cathode comprises about 80 wt % to about 98 wt % of said NMC811, about 1 wt % to about 10 wt % of said PVDF, and about 1 wt % to about 10 wt % of said carbon black.

12. (canceled)

13. The Li-ion battery of claim 9, wherein the anode comprises graphite, PVDF, and carbon black.

14. The Li-ion battery of claim 9, wherein the anode comprises about 80 wt % to about 98 wt % of said graphite, about 1 wt % to about 10 wt % of said PVDF, and about 1 wt % to about 10 wt % of said carbon black.

15. (canceled)

16. The Li-ion battery of claim 9, wherein said battery has an operational charging and discharging temperature in the range of about −120° C. to about 120° C.

17. A method assembling a Li-ion battery, said method comprising layering of a cathode, a separator material, an anode, and an electrolyte composition of claim 1.

18. The method of claim 17, wherein the battery is a coin cell type battery, wherein the cathode is coated on Al foil, the anode is coated on Cu foil, the separator material is Celgard2325, and the amount of electrolyte used is about 40 μL.

19. The method of claim 17, wherein the battery is a pouch cell type battery, wherein the cathode is attached via electrode tabs to an Al strip, the anode is attached via electrode tabs to a Ni strip, and the amount of electrolyte present in an amount in the range of about 2 g/Ah to about 4 g/Ah.

20. A method of supplying power, said method comprising using the battery of claim 9 to generate the flow of current and electricity such that the battery charges or discharges, wherein the battery discharges at a voltage in the range of about 2 V to about 5 V.
